(19) United States
(12) Patent Application Publication
(10) Pub. No.: US 2013/0260901 A1
(43) Pub. Date: Oct. 3, 2013

(54) GAMING APPARATUS, MATCH-UP CONTROL METHOD, COMPUTER-READABLE NON-TRANSITORY INFORMATION RECORDING MEDIUM HAVING STORED THEREIN PROGRAM, AND PROGRAM

(71) Applicant: KONAMI DIGITAL ENTERTAINMENT CO., LTD., Tokyo (JP)

(72) Inventor: Takamitsu NEMOTO, Minato-ku (JP)

(73) Assignee: Konami Digital Entertainment Co., Ltd., Tokyo (JP)

(21) Appl. No.: 13/852,820

(22) Filed: Mar. 28, 2013

(30) Foreign Application Priority Data
Mar. 29, 2012 (JP) 2012-077539

(51) Int. Cl. A63F 13/12

(52) U.S. Cl. CPC A63F 13/12
USPC 463/42

(57) ABSTRACT

When a screen is closed with the power being turned on, a gaming apparatus having executed a role playing game transitions to a standby state. The gaming apparatus transmits a reply request containing a game ID and the like. When determining that there is a response, the gaming apparatus exchanges time tables and higher-rank winner information. The gaming apparatus stores the received time table and higher-rank winner information in a game information memory. Next, when the screen is opened and the standby state ends, the gaming apparatus transitions to a normal state. Subsequently, the gaming apparatus sequentially causes both characters to match up against each other slot by slot based on the set time table of the user and the received time table of the competitor, and updates the higher-rank winner information.

### CROSS-REFERENCE TO RELATED APPLICATION

This application claims the benefit of Japanese Patent Application No. 2012-077539 filed on Mar. 29, 2012, the entire disclosure of which is incorporated by reference herein.

### FIELD

This application relates generally to a gaming apparatus, a match-up control method, a computer-readable non-transitory information recording medium having stored therein a program, and a program which further increase an opportunity of match-up in a game.

### BACKGROUND

Conventionally, video games (softwares) in various categories are developed in accordance with business-purpose or home gaming apparatuses. Among those games, role playing games have persistent favorites, and are supported by users in the widespread range of ages.

An example role playing game is a type which allows a user to manipulate a main character (player character) in a virtual space (for example, a field, a dungeon) to explore such a virtual space, and to accomplish a predetermined object. The player character fights against enemy characters encountering during the game, increases, for example, the experience point and a performance point upon winning of the battle, and grows up so that the player character becomes able to fight evenly against a further stronger enemy character.

As an example conventional technology of a gaming apparatus that executes a role playing game, there is proposed a technology of a gaming apparatus that allows a user to get into the main character itself to enjoy the game (see, for example, Unexamined Japanese Patent Application Kokai Publication No. 2003-062343).

According to the above-explained conventional role playing games, when a battle starts during the game, the user sequentially gives an instruction to the player character. That is, at the time of the battle, in general, an attack opportunity is alternately given to the player character and an enemy character, and in the turn of the player character, the user selects and gives a desired instruction (for example, an instruction of an attack, a defense, or a recovery) every time such a turn comes. The user assesses the tactical situation, and selects the optimized instruction at that time point, and gives such an instruction to the player character.

According to such a battle style, however, the battle does not advance (or the user becomes a loser one-sidedly) unless the user successively gives an instruction. Hence, the opportunity at which the battle occurs is limited to only the case in which the user is actually playing the game, and thus the opportunity of match-up is inevitably restricted within such a case.

In the case of portable gaming apparatuses, for example, a user often goes outside while carrying such a portable gaming apparatus. Even if the user passes through another user (another portable gaming apparatus) at an outside location where the user goes, a match-up does not come into effect (is not set up) according to the conventional battle style. That is, in order to let the users to have a match-up, it is necessary that both users should be playing the game (to set both users as match-up competitors), and also the battle should be ended within a short time of such passing with respective battle instructions being completed, but this is substantially impracticable.

Hence, a development of a technology is desired which allows a user to carry out a match-up when a user passes through another user in games like a role playing game.

The present invention has been made in order to address the above-explained disadvantages, and it is an objective of the present invention to provide a gaming apparatus, a match-up control method, a computer-readable non-transitory information recording medium having stored therein a program, and a program which further increase an opportunity of match-up in a game.

### SUMMARY

A gaming apparatus according to a first embodiment of the present invention causes the object of a user to match up against another object, and includes a setter, a transmitter, a receiver, a match-up controller, a determiner, and an information memory.

The setter sets a time table defining an activity sequence for an object (for example, a face card or a character representing the user or the like).

The transmitter transmits the set time table to another gaming apparatus through, for example, a wireless communication.

The receiver receives a competitor's time table transmitted from the another gaming apparatus through, for example, a wireless communication.

The match-up controller causes both objects to match up in sequence based on the set time table of the user and the received time table of the competitor. That is, the match-up controller causes both objects to match up against each other defined in both time tables.

The determiner determines whether the user has won or lost based on a match-up result of the matched objects.

The information memory stores information on another user having a high winning rate with reference to the user based on the determination.

The match-up of both objects are performed in sequence in accordance with both exchanged time tables. That is, the object of the user attacks or the like in accordance with the time table set by the user, while the competitor object attacks or the like in accordance with a time table set by another user. Hence, as far as the time tables have been exchanged when users (gaming apparatuses) pass through each other, both objects can be caused to match up against each other after such a time table exchange. Moreover, information on another user having a high winning rate is also stored.

This results in a further increase of an opportunity of match-up in the game.

A gaming apparatus according to a second embodiment of the present invention causes an object of a user to match up against another object, and includes a setter, a transmitter, a receiver, a match-up controller, a determiner, and an information memory.

The setter sets, with a slot necessary for a match-up being as a unit, the object (for example, a face card or a character representing the user or the like) of the user in a time table defining each slot up to a predetermined number in association with each slot.

The transmitter transmits the set time table to another gaming apparatus through, for example, a wireless communication.

The receiver receives a competitor's time table transmitted from the another gaming apparatus through, for example, a wireless communication.

The match-up controller causes both objects to match up for each slot based on the set time table of the user and the received time table of the competitor. That is, the match-up controller causes both objects to match up against each other defined in both time tables.

The determiner determines whether the user has won or lost based on a match-up result of the matched-up objects against each other.

The information memory stores information on another user having a high winning rate with reference to the user based on the determination.

The match-up of both objects are performed for each slot in accordance with exchanged both time tables. That is, the object of the user attacks or the like in accordance with the time table set by the user, while the competitor object attacks or the like in accordance with a time table set by another user. Hence, as far as the time tables have been exchanged when users (gaming apparatuses) passes through each other, both objects can be caused to match up against each other after such a time table exchange. Moreover, information on another user having a high winning rate is also stored.

This results in a further increase of an opportunity of match-up in the game.

A gaming apparatus according to a third embodiment of the present invention causes a character available for a user to match up against a character available for a competitor, and includes a memory, a setter, a communicator, a match-up controller, a determiner, and an information memory.

The memory stores information on a plurality of characters available for the user.

The setter sets, with a slot necessary for a match-up being as a unit, a character selected among the plurality of stored characters and an instruction to the selected character in a time table defining each slot up to a predetermined number in association with each slot.

The communicator transmits the set time table to another gaming apparatus and also receives a competitor's time table transmitted from the another gaming apparatus at a predetermined timing (for example, in a standby state) through, for example, a wireless communication.

The match-up controller causes both characters to match up for each slot based on the set time table of the user and the received time table of the competitor. That is, the match-up controller causes both characters defined in both time tables to match up against each other for each slot.

The determiner determines whether the user has won or lost based on a match-up result of the matched-up characters against each other.

The information memory stores information on another user having a high winning rate with reference to the user based on the determination.

The match-up of both characters are performed for each slot in accordance with exchanged both time tables. That is, the character of the user attacks or the like in accordance with the time table set by the user, while the competitor character attacks or the like in accordance with a time table set by another user. Hence, as far as the time tables have been exchanged when users (gaming apparatuses) passes through each other, both characters can be caused to match up against each other after such a time table exchange. Moreover, information on another user having a high winning rate is also stored.

This results in a further increase of an opportunity of match-up in the game.

The communicator may transmit the set time table and the stored winner information to another gaming apparatus and receives the time table of the competitor and the winner information transmitted from the another gaming apparatus at a predetermined timing.

When the gaming apparatus transitions to a standby state, the communicator may exchange the time tables with another gaming apparatus through a wireless communication, and the match-up controller may cause both characters to match up against each other after the gaming apparatus transitions from the standby state to a normal state.

A match-up control method according to a fourth embodiment of the present invention is executed by a gaming apparatus which comprises a setter, a transmitter, a receiver, a match-up controller, a determiner, and an information memory, and which causes an object of a user to match up against another object. The match-up control method includes a setting step, a transmitting step, a receiving step, a match-up control step, a determining step, and an information memory step.

In the setting step, the setter is caused to set a time table defining an activity sequence for an object (for example, a face card or a character representing the user or the like).

In the transmitting step, the transmitter is caused to transmit the set time table to another gaming apparatus through, for example, a wireless communication.

In the receiving step, the receiver is caused to receive a competitor's time table transmitted from the another gaming apparatus through, for example, a wireless communication.

In the match-up control step, the match-up controller is caused to allow both objects to match up in sequence based on the set time table of the user and the received time table of the competitor. That is, in the match-up control step, both objects are caused to match up against each other defined in both time tables.

In the determining step, the determiner is caused to determine whether the user has won or lost based on a match-up result of the matched objects.

In the information memory step, the information memory is caused to store information on another user having a high winning rate with reference to the user based on the determination.

The match-up of both objects are performed in sequence in accordance with both exchanged time tables. That is, the object of the user attacks or the like in accordance with the time table set by the user, while the competitor object attacks or the like in accordance with a time table set by another user. Hence, as far as the time tables have been exchanged when users (gaming apparatuses) pass through each other, both objects can be caused to match up against each other after such a time table exchange. Moreover, information on another user having a high winning rate is also stored.

This results in a further increase of an opportunity of match-up in the game.

A computer-readable non-transitory information recording medium according to a fifth embodiment of the present invention stores a program that causes a computer (including electric apparatuses) to serve as the above-explained gaming apparatus.

A program according to a sixth embodiment of the present invention is a computer-readable non-transitory program and causes a computer (including electric apparatuses) to serve as the above-explained gaming apparatus.

The above-explained program is recordable in a computer-readable information recording medium, such as a compact disc, a flexible disk, a hard disk, a magneto-optical disk, a digital video disk, a magnetic tape, or a semiconductor memory.

The above-explained program is capable of being distributed and sold over a computer communication network independently from a computer that executes the program. The above-explained information recording medium is capable of being distributed and sold separately from the computer.

According to the present invention, it becomes possible to further increase an opportunity of match-up in a game.

### BRIEF DESCRIPTION OF THE DRAWINGS

A more complete understanding of this application can be obtained when the following detailed description is considered in conjunction with the following drawings, in which:

FIGS. 1A and 1B are exemplary diagrams illustrating an external view of a typical portable gaming apparatus realizing a gaming apparatus according to the present invention;

FIG. 2 is a block diagram illustrating a general structure of a portable gaming apparatus;

FIG. 3 is an exemplary diagram illustrating a general structure of a gaming apparatus according to a first embodiment of the present invention;

FIG. 4 is an exemplary diagram for explaining an example time table;

FIG. 5A is an exemplary diagram for explaining how to dispose a monster character or the like in a time table setting area;

FIG. 5B is an exemplary diagram for explaining how to dispose the monster character or the like in the time table setting area;

FIG. 5C is an exemplary diagram for explaining how to dispose the monster character or the like in the time table setting area;

FIG. 6A is an exemplary diagram for explaining an icon disposed in the time table setting area;

FIG. 6B is an exemplary diagram for explaining an icon disposed in the time table setting area;

FIG. 6C is an exemplary diagram for explaining an icon disposed in the time table setting area;

FIG. 6D is an exemplary diagram for explaining an icon disposed in the time table setting area;

FIG. 7A is an exemplary diagram for explaining a match-up in accordance with a time table;

FIG. 7B is an exemplary diagram for explaining a match-up in accordance with a time table;

FIG. 8A is an exemplary diagram for explaining an example game screen;

FIG. 8B is an exemplary diagram for explaining an example game screen;

FIG. 9 is a flowchart illustrating an example time table setting process according to the first embodiment of the present invention;

FIG. 10 is a flowchart illustrating an example match-up control process according to the first embodiment of the present invention;

FIG. 11 is an exemplary diagram for explaining example preferential instruction information;

FIG. 12A is an exemplary diagram for explaining an example intervention operation;

FIG. 12B is an exemplary diagram for explaining an example intervention operation;

FIG. 12C is an exemplary diagram for explaining an example intervention operation;

FIG. 12D is an exemplary diagram for explaining an example intervention operation;

FIG. 13 is an exemplary diagram for explaining a match-up in accordance with preferential instruction information and a time table;

FIG. 14 is a flowchart illustrating an example match-up control process according to a second embodiment of the present invention;

FIG. 15 is an exemplary diagram illustrating a general structure of a gaming apparatus according to a third embodiment of the present invention;

FIG. 16 is an exemplary diagram for explaining an example received time table;

FIG. 17 is a flowchart illustrating an example time table exchanging process according to a third embodiment of the present invention;

FIG. 18 is a flowchart illustrating an example match-up control process according to the third embodiment of the present invention;

FIG. 19A is an exemplary diagram for explaining example match-up record information;

FIG. 19B is an exemplary diagram for explaining example higher-rank winner information;

FIG. 19C is an exemplary diagram for explaining example received higher-rank winner information;

FIG. 19D is an exemplary diagram for explaining example comprehensive winner information;

FIG. 20 is a flowchart illustrating an example time table exchanging process according to a fourth embodiment of the present invention; and

FIG. 21 is a flowchart illustrating an example match-up control process according to the fourth embodiment of the present invention.

### DETAILED DESCRIPTION

Embodiments of the present invention will be explained below. In the following explanation, in order to facilitate understanding to the present invention, an embodiment in which the present invention is applied to a portable gaming apparatus will be explained, but the present invention is likewise applicable to various information processing devices, such as computers, PDAs, mobile phones, and smart phones. That is, embodiments described below are merely for explanation, and are not for limiting the scope of the present invention. Accordingly, it is possible for those skilled in the art to realize an embodiment in which each or all components are replaced with equivalents, and such an embodiment is within the scope of the present invention.

### External View of Portable Gaming Apparatus

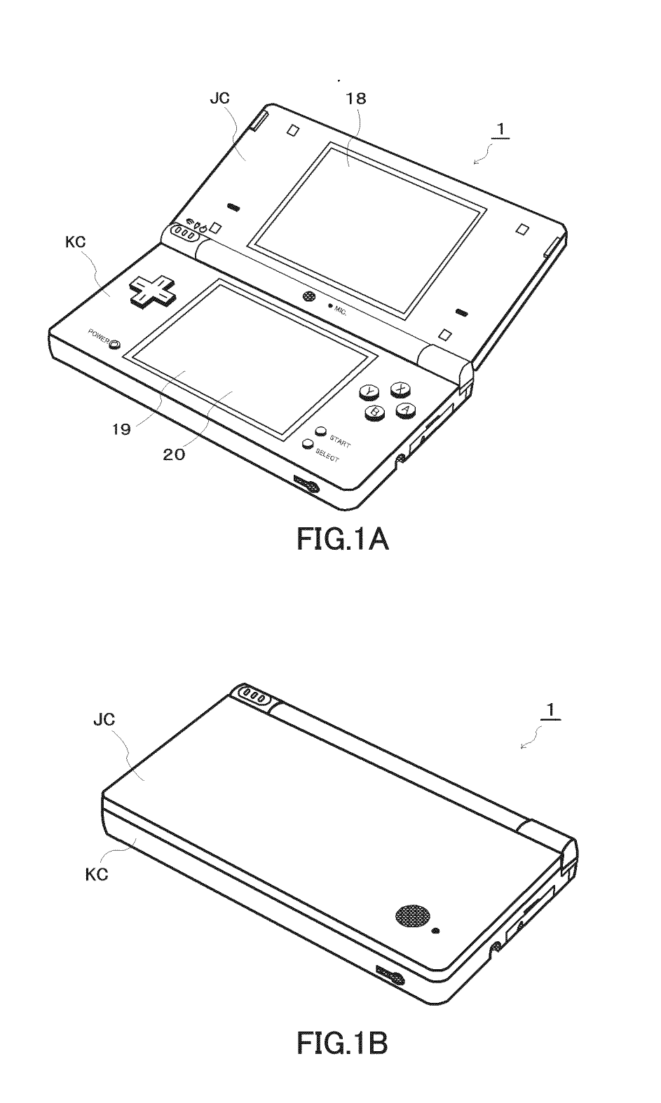

FIGS. 1A and 1B are exemplary diagrams illustrating an external view of a typical portable gaming apparatus 1 realizing a gaming apparatus according to an embodiment of the present invention. As illustrated in FIG. 1A, the portable gaming apparatus 1 has respective components built in an upper casing JC and a lower casing KC.

For example, a first display 18 is built in the upper casing JC, and a second display 19 and a touch panel 20 are built in the lower casing KC.

The portable gaming apparatus 1 is a foldable (clamshell) apparatus, and has the upper casing JC and the lower casing KC pivoted through a joined portion. That is, the upper casing JC is freely openable and closable, and as illustrated in FIG. 1A, when a user plays a game, the portable gaming apparatus 1 is used with the upper casing JC being opened, and when the user does not use the gaming apparatus 1 or carries the gaming apparatus 1, as illustrated in FIG. 1B, the upper casing JC is closed. As will be discussed later, the portable gaming apparatus 1 is capable of detecting such opening/closing of the upper casing JC, and of transitioning a state from a standby state (suspended state) to a normal state, and from the normal state to the standby state.

### Structure of Portable Gaming Apparatus

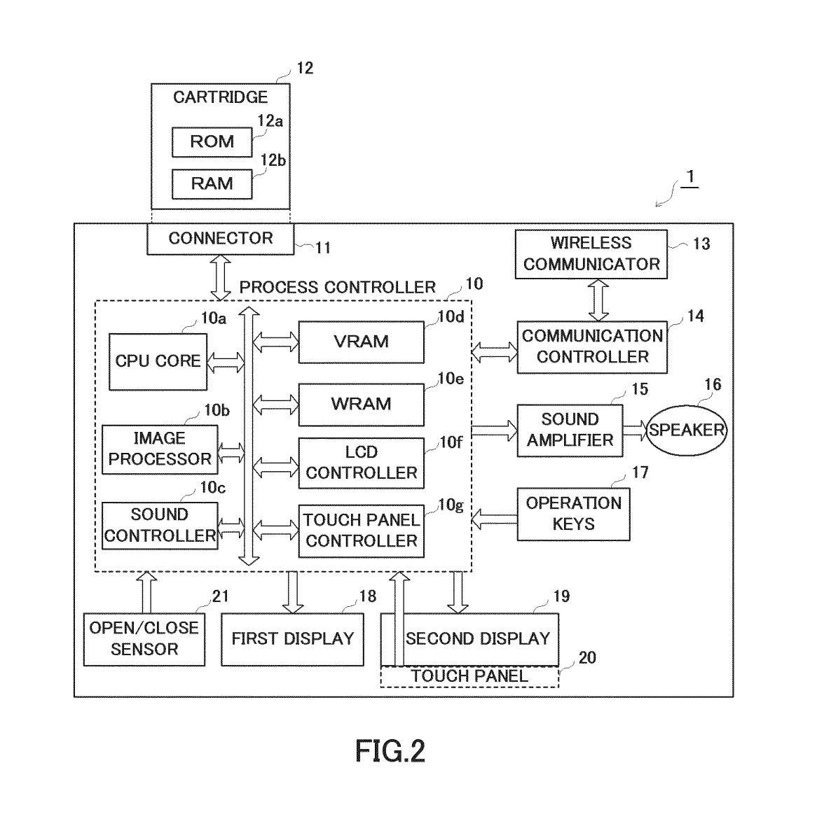

FIG. 2 is a block diagram illustrating a general structure of the above-explained portable gaming apparatus 1. The following explanation will be given with reference to this figure.

The portable gaming apparatus 1 includes a process controller 10, a connector 11, a cartridge 12, a wireless communicator 13, a communication controller 14, a sound amplifier 15, a speaker 16, operation keys 17, the first display 18, the second display 19, the touch panel 20, and an open/close sensor 21.

The process controller 10 includes a CPU (Central Processing Unit) core 10a, an image processor 10b, a sound processor 10c, a VRAM (Video Random Access Memory) 10d, a WRAM (Work RAM) 10e, an LCD (Liquid Crystal Display) controller 10f, and a touch panel controller 10g.

The CPU core 10a exchanges control signals and data with each connected components, and controls the whole portable gaming apparatus 1. More specifically, with the cartridge 12 being attached to the connector 11, the CPU core 10a reads a program and data stored in a ROM (Read Only Memory) 12a in the cartridge 12, and executes a predetermined process.

The image processor 10b performs image processing on data read from the ROM 12a in the cartridge 12 and data processed by the CPU core 10a, and stores the processed data in the VRAM 10d.

The sound processor 10c includes, for example, a predetermined number of sound sources, and creates effect sounds and music data to be created in accordance with the advancement of a game.

The VRAM 10d stores information to be displayed, and stores data (image data) having undergone the image processing by, for example, the image processor 10b.

The WRAM 10e stores, for example, work data necessary when the CPU core 10a executes various processes in accordance with a program.

The LCD controller 10f controls the first display 18 and the second display 19, and causes those displays to display a predetermined display image. More specifically, the LCD controller 10f converts image data stored in the VRAM 10d into display signals at a predetermined synchronization timing, and outputs the display signals to the first display 18 and the second display 19. For example, the LCD controller 10f causes the first display 18 to display a main game image, and causes the second display 19 to display an operation instruction image (for example, a setting image) including icons and the like.

The touch panel controller 10g detects a contact (touch) to the touch panel 20 by a touch pen or a finger of the user. For example, with the second display 19 being displaying icons and the like, the touch panel controller 10g detects a contact position or the like on the touch panel 20, and accepts an operation given to a corresponding icon or the like.

The connector 11 is a terminal connectable with the cartridge 12 in a freely detachable manner, and exchanges predetermined data with the cartridge 12 when connected with the cartridge 12.

The cartridge 12 includes the ROM 12a, and a RAM (Random Access Memory) 12b.

The ROM 12a stores a program for realizing a game, and image data, sound data and the like accompanying with the game.

The RAM 12b stores various data indicating an advancement status or the like of the game.

With such a cartridge 12 being loaded, when the power of the portable gaming apparatus 1 is turned on, the program in the ROM 12a is executed by the CPU core 10a, and thus the gaming apparatus of this embodiment is realized.

The wireless communicator 13 is a unit that performs wireless communication with another portable gaming apparatus 1 and a predetermined wireless access point, and exchanges predetermined data therewith through an unillustrated antenna (for example, a built-in antenna).

A unique MAC (Media Access Control) address is allocated to the wireless communicator 13.

The communication controller 14 controls the wireless communicator 13, and serves as a mediator for a wireless communication performed between the process controller 10 and the process controller 10 of another portable gaming apparatus 1 in accordance with a predetermined protocol.

When the portable gaming apparatus 1 is connected to the Internet through an adjacent wireless access point or the like, the communication controller 14 serves as a mediator for a wireless communication performed between the process controller 10 and the wireless access point or the like in accordance with a protocol compatible with a wireless LAN. For example, the communication controller 14 may perform wireless communication with another portable gaming apparatus 1 through a server or the like over the Internet.

The sound amplifier 15 amplifies sound signals generated by the process controller 10 (sound processor 10c), and supplies the amplified signals to the speaker 16.

The speaker 16 is, for example, stereo speakers, and outputs predetermined music sounds, effect sounds, and the like in accordance with the sound signals amplified by the sound amplifier 15.

The operation keys 17 are, for example, a plurality of key switches disposed on the portable gaming apparatus 1 accordingly, and accepts predetermined instruction inputs in accordance with an operation given by the user.

The first display 18 and the second display 19 are each an LCD or the like, controlled by the LCD controller 10f, and display game images or the like as needed.

The second display 19 displays icons and the like for accepting a contact (touch operation) to the touch panel 20.

The touch panel 20 is disposed in a manner superimposed on the front face of the second display 19, and accepts an input through a contact by a touch pen or a finger of the user.

The touch panel 20 is, for example, a pressure-sensitive touch sensor panel, and detects pressure by a touch pen or the like to detect a touch operation, the position (touch position) thereof, and the like. The touch panel 20 may detect a contact of a finger of the user or the like through, for example, a change in an electrostatic capacitance.

The open/close sensor 21 detects the opening/closing of the upper casing JC. That is, the open/close sensor 21 detects that the opened upper casing JC is closed or the closed upper casing JC is opened.

### First Embodiment

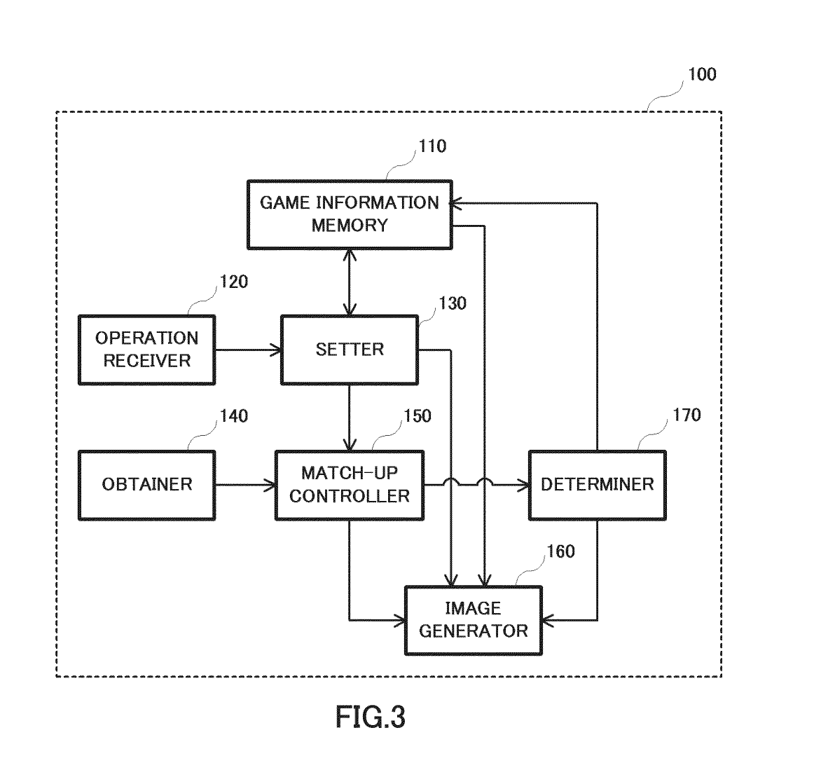

FIG. 3 is a block diagram illustrating a general structure of a gaming apparatus 100 according to a first embodiment of the present invention which is realized by the above-explained portable gaming apparatus 1. This gaming apparatus 100 provides, for example, a role playing game to the user which allows a player character (main character) to proceed through an adventure together with a partner monster character.

In this role playing game, when a player meets an enemy monster character or the like during the adventure, the partner monster character is matched up the enemy monster character in accordance with successive instructions (time table to be discussed later) from the player character (more specifically, the user). As an example, the player character is capable of collecting monster characters as items (monster items) captured in another dimension (another world) in the game, of using the monster item during a battle, and of causing the partner monster character to transform (change) into a desired monster character for a match-up with an enemy monster character.

A detailed explanation will now be given below of the gaming apparatus 100 according to the first embodiment of the present invention.

As illustrated in FIG. 3, the gaming apparatus 100 includes a game information memory 110, an operation receiver 120, a setter 130, an obtainer 140, a match-up controller 150, an image generator 160, and a determiner 170.

The game information memory 110 stores various information necessary for the game.

The game information memory 110 stores object information containing, for example, images, HP (life points), MP (Magic points), experience points, possessed money, and attributes of the player character and various monster characters. The monster characters include, for example, a partner monster character, a captured monster character (a monster character that becomes able to transform into different forms), and an enemy monster character.

In addition, the game information memory 110 stores object information on woods, stones, water, buildings and the like constituting a game field.

The game information memory 110 stores a time table for instructing a partner monster character regarding a battle procedure. This time table is for setting successive battle instructions for the partner monster character (more specifically, a monster character that the user wants to transform) at the time of the match-up against an enemy monster character.

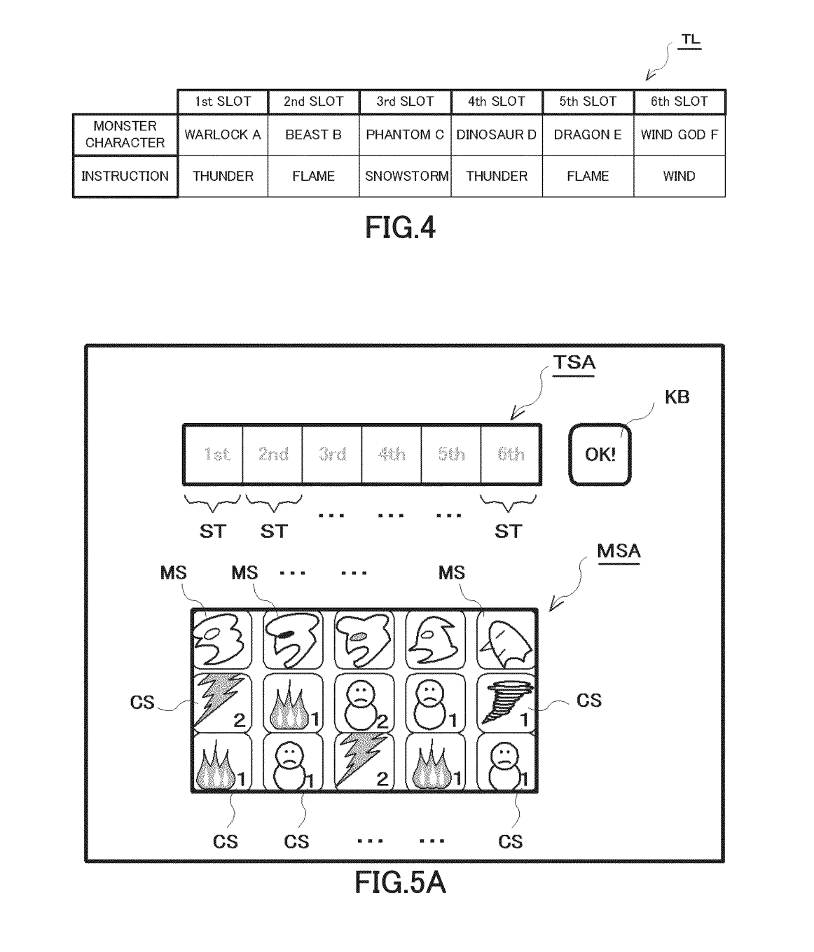

More specifically, the game information memory 110 stores a time table TL illustrated in FIG. 4. The time table TL allows a setting of a combination of a monster character form that the user wants the partner monster character to transform into and an instruction (command) to be executed by the now transformed partner monster character in accordance with each slot (first to sixth slots).

The slot indicates a period of a battle (a battle time) that is a minimum unit. Hence, the time table TL permits a setting of the contents of the battle up to six times. The number of slots is merely an example, and can be changed as needed.

An example partner monster character settable in the time table TL is a monster character (possessed monster item) captured in another dimension in the game. The settable partner monster character is not limited to such a monster character captured in another dimension, and can be changed as needed.

That is, the time table TL permits a setting of a combination of the monster character form that the user wants to the partner monster character to transform into among the monster items possessed by the player character and an instruction to be executed by this monster character up to a predetermined number.

Prior to the start of the battle, the user considers the force, attribute, and the like of an enemy monster character or the like that is a match-up competitor, and disposes an effective monster character against those properties and an instruction to be given to this monster character in the time table TL. In FIG. 4, the monster character form and the instruction are indicated by respective appellations, but this is to facilitate understanding, and in practice, it is presumed that respective identification information (for example, monster ID and command ID) are stored.

How to set such a time table TL will be explained in detail later together with the setter 130. The game information memory 110 stores various symbols, icons, and the like used for a display (setting image to be discussed later) when the setter 130 sets the time table TL.

The above-explained WRAM 10e and the like serve as such a game information memory 110.

Returning to FIG. 3, the operation receiver 120 receives an operation input given by the user. That is, the operation receiver 120 sequentially receives various operations for advancing the game.

For example, the operation receiver 120 receives an operation for moving (a desired action) the player character or the like in the game field accordingly. Moreover, while moving in the field, when the player character meets an enemy monster character or the like, a battle is started. In this case, prior to the battle, the operation receiver 120 receives an operation for setting a monster character or the like in the above-explained time table TL.

The above-explained operation keys 17 and touch panel 20 serve as such an operation receiver 120.

The setter 130 sets, prior to the start of a battle, a monster character or the like in the time table TL in the above-explained game information memory 110 in accordance with the operation instruction received by the operation receiver 120.

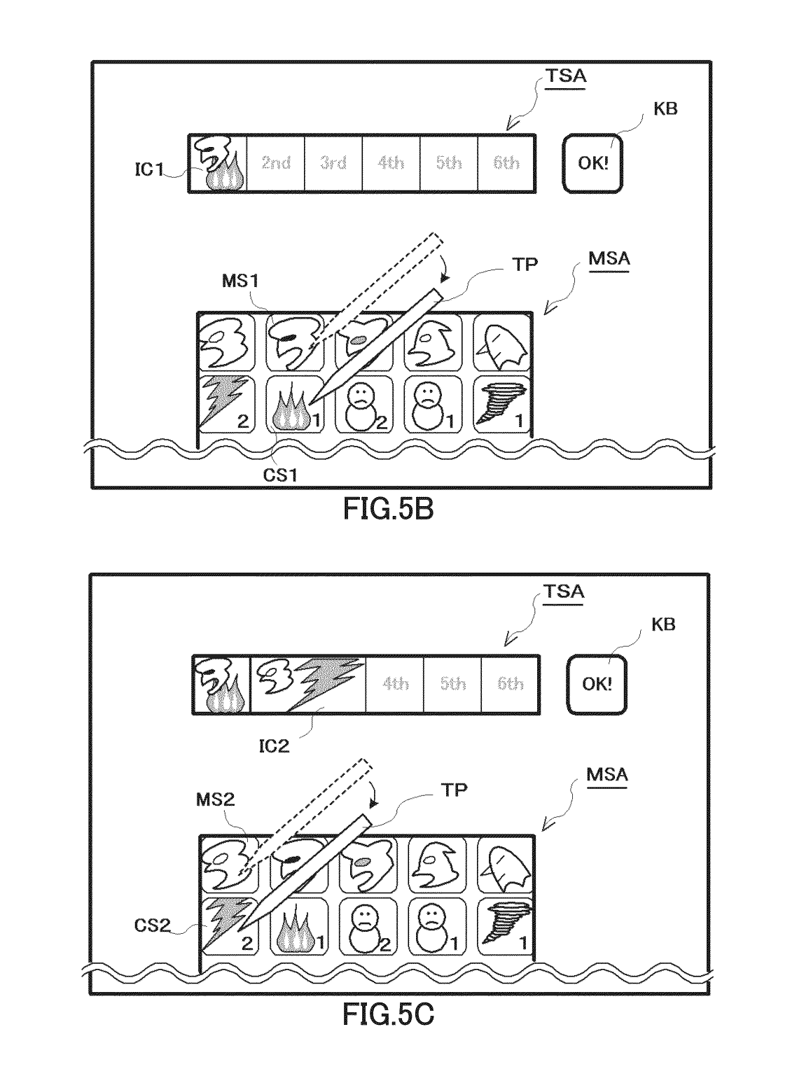

The following explanation will be given of an example case in which the image generator 160 to be discussed later is displaying a setting image illustrated in FIG. 5A on the above-explained second display 19, and a setting is made by the setter 130.

As illustrated in FIG. 5A, the setting image contains a time table setting area TSA, a set button KB, and a monster selecting area MSA. The setter 130 sets a monster character or the like in the time table setting area TSA (eventually, the time table TL) in accordance with an operation instruction given by the user with such a setting image being displayed.

The time table setting area TSA is divided into, for example, six slots ST. Each slot ST indicates a period of a battle. Hence, the time table setting area TSA allows a setting of the procedures of the battle up to six times. That is, the time table setting area TSA is the basis of the time table TL stored in the game information memory 110.

Disposed in the monster selecting area MSA are a monster symbol MS and a command (instruction) symbol CS in a selectable manner.

An example monster symbol MS indicates the symbol of a monster character captured in another dimension in the game. That is, a monster symbol MS in accordance with a monster item captured by the player character (user) is disposed as the monster symbol MS.

A plurality of command symbols CS are disposed below the monster symbol MS, and indicate skills (for example, attack skills) available for the monster character. For example, the command symbols CS contain various attack skills, such as thunder, flame, ice (snowstorm), and wind (tornado). A number at the lower right of the command symbol CS indicates the use amount (necessary amount) of the slots ST. The way of displaying such a use amount is optional, and is changeable as needed. For example, the use amount of the slots ST may be indicated by the roll of a dice instead of a number.

The user is allowed to select an arbitrary combination of the monster symbol MS and the command symbol CS in the monster selecting area MSA.

As an example, as illustrated in FIG. 5B, when the user operates a touch pen TP to select a monster symbol MS 1 and a command symbol CS 1 therebelow through the touch panel 20, the setter 130 disposes an icon IC (IC1) of such a combination in the slot ST in the time table setting area TSA. As an example, the icons IC are disposed from the left end slot ST in the sequential order.

Next, as illustrated in FIG. 5C, when a monster symbol MS2 and a command symbol CS2 therebelow are selected, the setter 130 disposes an icon IC2 of such a combination in the next (right) slot ST. In this case, since the number at the lower right of the command symbol CS2 is 2 (the use amount of the slots ST is 2), the icon IC2 takes over a laterally long slot using the two slots ST.

When setting such icons IC in the time table setting area TSA and when the relationship of the successive icons CS, that is, the combinations of the monster characters and the instructions thereof set in the adjoining slots meet a preset order, the setter 130 combines both icons IC to generate another icon IC, and replaces the former icons IC with the generated icon IC. That is, when the relationship between a monster character and an instruction selected beforehand, and, a monster character and an instruction selected later is in a relationship of a preset combo skill (combination attack skill), the setter 130 replaces those icons with the icon IC of such a combo skill.

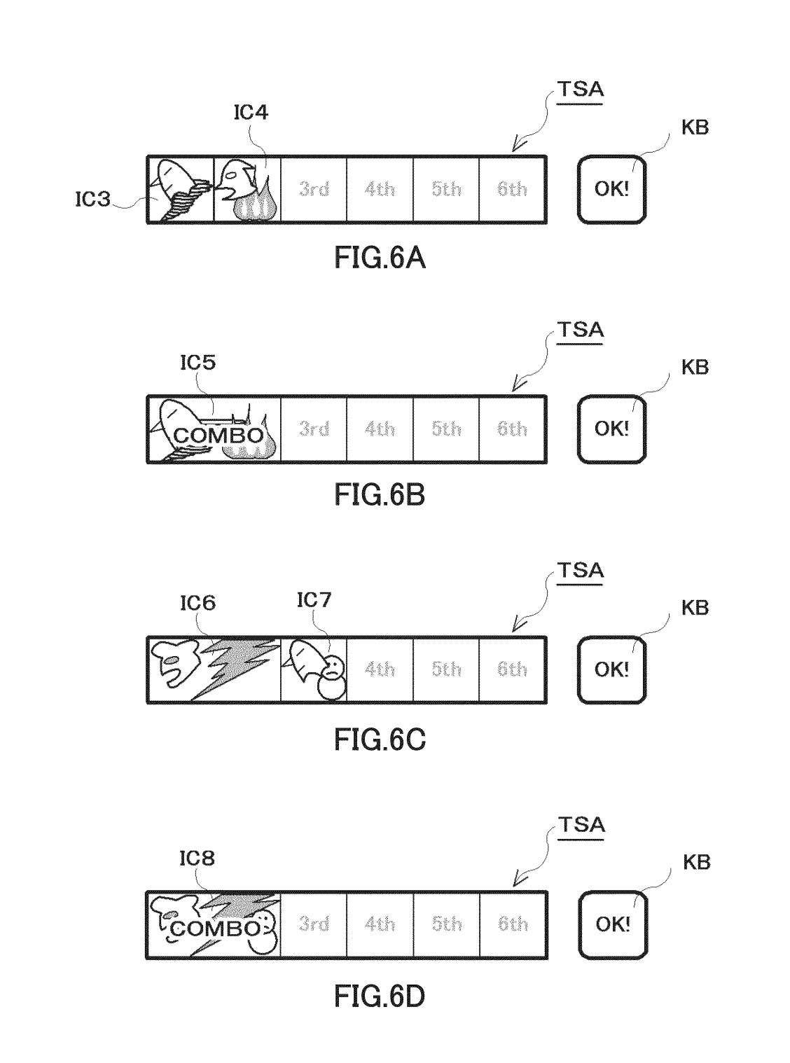

For example, when an icon IC3 and an icon IC4 illustrated in FIG. 6A are in a relationship of a combo skill, as illustrated in FIG. 6B, the setter 130 replaces those icons with an icon IC5 that combines those icons.

This is because the attack skill (for example, tornado) of a monster character indicated by the icon IC3 and the attack skill (for example, flame) of a monster character indicated by the icon IC4 are defined in advance as a combo skill Note that a combo skill is kept in secret until such a combo skill is actually used (activated) in the game. That is, when a combination of the successive monster characters and attack skills is used in an actual battle, a combo skill is then activated, and becomes known to the user.

Hence, the replacement of the combined icon IC5 as illustrated in FIG. 6B is limited only when the combo skill has been already activated, and when the combo skill has not been activated (when the combo skill is selected at the first time), the icons are not combined, and as illustrated in FIG. 6A, the icons IC3 and IC4 are disposed as those are.

Depending on the combo skill, the number of slots after the combination increases or decreases in some cases in comparison with the number of slots (total number) before such a combination.

For example, as illustrated in FIG. 6C, when an icon IC6 and an icon IC7 are in the relationship of a combo skill (already activated), as illustrated in FIG. 6D, the setter 130 replaces those icons with an icon IC8 combining those icons. In this case, the number of slots used by the icon IC8 after the combination (two slots) is smaller than the number of slots used by the icons IC6 and IC7 before the combination (three slots).

Conversely, the number of slots of the icon IC after the combination increases in some cases in comparison with the number of slots of the icons IC before the combination.

The user selects desired monster character and command in this manner, and successively disposes the corresponding icons IC in the time table setting area TSA (each slot ST). When the disposal of the icon IC in each slot ST completes, and the set button KB is operated, the setter 130 generates the time table TL from the time table setting area TSA, and stores the generated time table TL in the game information memory 110. That is, the setter 130 converts each icon IC in the time table setting area TSA into the identification information (monster ID) of the monster character and the identification information (command ID) of the command, and set those pieces of identification information in each slot of the time table TL.

When there is unused slot ST (no icon IC is disposed) and the set button KB is operated, the setter 130 sets a monster character and an instruction in the unused slot ST accordingly in accordance with a predetermined logic or the like, generates the time table TL, and stores the generated time table TL in the game information memory 110.

The above-explained CPU core 10a, the WRAM 10e, and the like serve as such a setter 130.

Returning to FIG. 3, the obtainer 140 obtains the time table of a match-up competitor (an enemy monster character). The time table of the enemy monster character employs the same structure as that of the above-explained time table TL illustrated in FIG. 4.

When the user plays this game in solo (single-player play mode), the game mode becomes a CPU match-up mode. Accordingly, the obtainer 140 generates a time table accordingly in accordance with a predetermined logic or the like, and obtains this time table as the time table of the enemy monster character.

Conversely, when the user plays this game in a manner capable of having a match-up with another player (multiple-player play mode), the obtainer 140 obtains the time table of an enemy monster character transmitted from another gaming apparatus 100 through the above-explained wireless communicator 13 and the like. At this time, it is not limited to a case in which the adjacent gaming apparatuses 100 directly perform wireless match-up, but also a case in which remote gaming apparatuses 100 connected together over the Internet or the like perform Internet match-up. Hence, the obtainer 140 obtains the time table of an enemy monster character from adjacent or remote other gaming apparatus 100 (the gaming apparatus 100 corresponding to the encountering enemy monster character).

The above-explained CPU core 10a, the wireless communicator 13, the communication controller 14, and the like serve as such an obtainer 140.

The match-up controller 150 controls a match-up between the monster characters based on the time tables of both enemy and partner.

That is, the match-up controller 150 causes both monster characters to fight against each other based on the time table TL stored in the game information memory 110 (set by the setter 130) and the time table (employing the same structure as that of the time table TL) of the enemy monster character obtained by the obtainer 140.

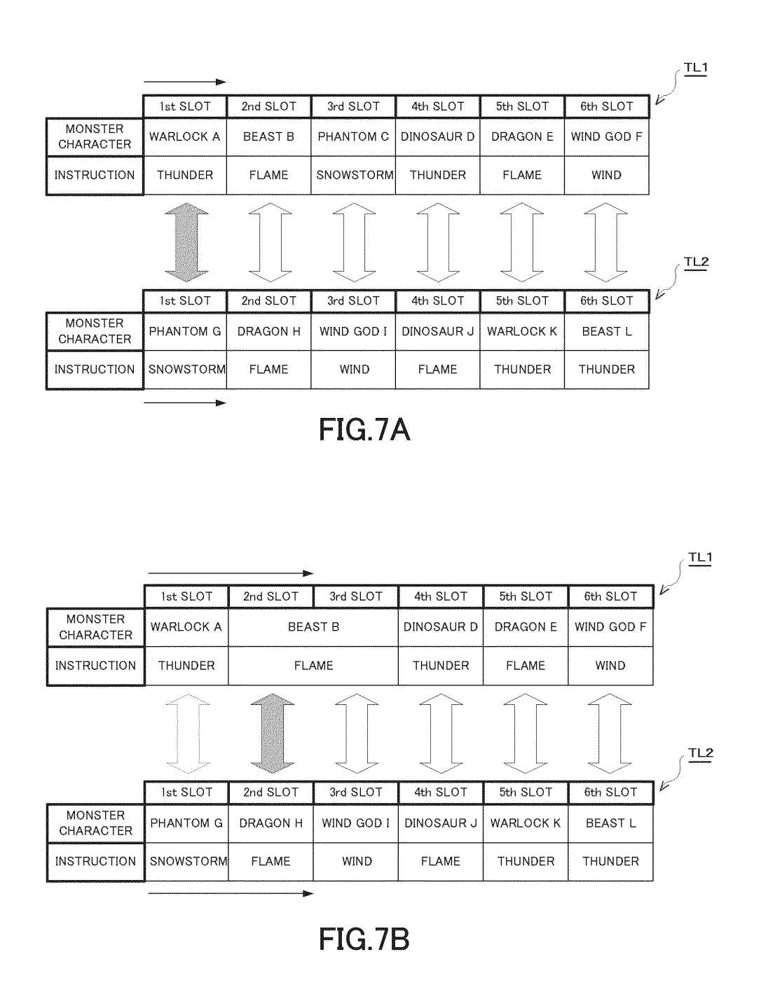

More specifically, as illustrated in FIG. 7A, the match-up controller 150 causes both monster characters in the same slot in a sequential order from the first slot based on a own time table TL1 and an enemy time table TL2. For example, in the battle of the first slot, a warlock A in the own time table TL1 and a phantom G in the enemy time table TL2 are caused to fight against each other by the respective instructions (thunder and snowstorm). That is, the warlock A attacks the phantom G with thunder, while the phantom G attacks the warlock A with snowstorm.

The match-up controller 150 sets a antecedent and a succedent based on, for example, information on the partner monster character and the enemy monster character. As an example, the antecedent and the succedent are set based on the experience points of both characters and other information (for example, quickness), and are maintained during the successive battles (all slots). How to set the antecedent and the succedent is optional, and can be changed as needed. The antecedent and the succedent may be set for each slot. For example, a random number may be generated for each slot and for each time, and the antecedent and the succedent may be set based on the value of such a random number.

The match-up controller 150 calculates a damage from the competitor when an attack is made, and subtracts the value of the damage from the HP (life points) of the competitor stored in the game information memory 110.

As illustrated in FIG. 7B, when an instruction (flame) by two slots is set in the second and third slots of the own time table TL1, in the battle of the second slot, the match-up controller 150 performs a control in such a way that a beast B in the own time table TL1 does not attack but a dragon H in the enemy time table TL2 attacks (flame). In the battle of the third slot, the beasts B in the time table TL1 and a wind god I in the time table TL2 are caused to fight against each other by the respective instructions (flame and wind).

That is, when multiple slots are used, the match-up controller 150 activates this instruction at the last slot (the last slot in the multiple slots).

When a combination of the characters and instructions set in adjoining slots in the time table is in a relationship of a combo skill (not activated yet) as explained above, the match-up controller 150 activates this combo skill, and, for example, attacks the competitor. In this case, since the combo skill is disposed across multiple slots, the match-up controller 150 activates the combo skill at the last slot (the last slot in the combined slots).

The above-explained CPU core 10a and the like serve as such a match-up controller 150.

Returning to FIG. 3, the image generator 160 generates a game image (a field image and a match-up image), a setting image, and the like.

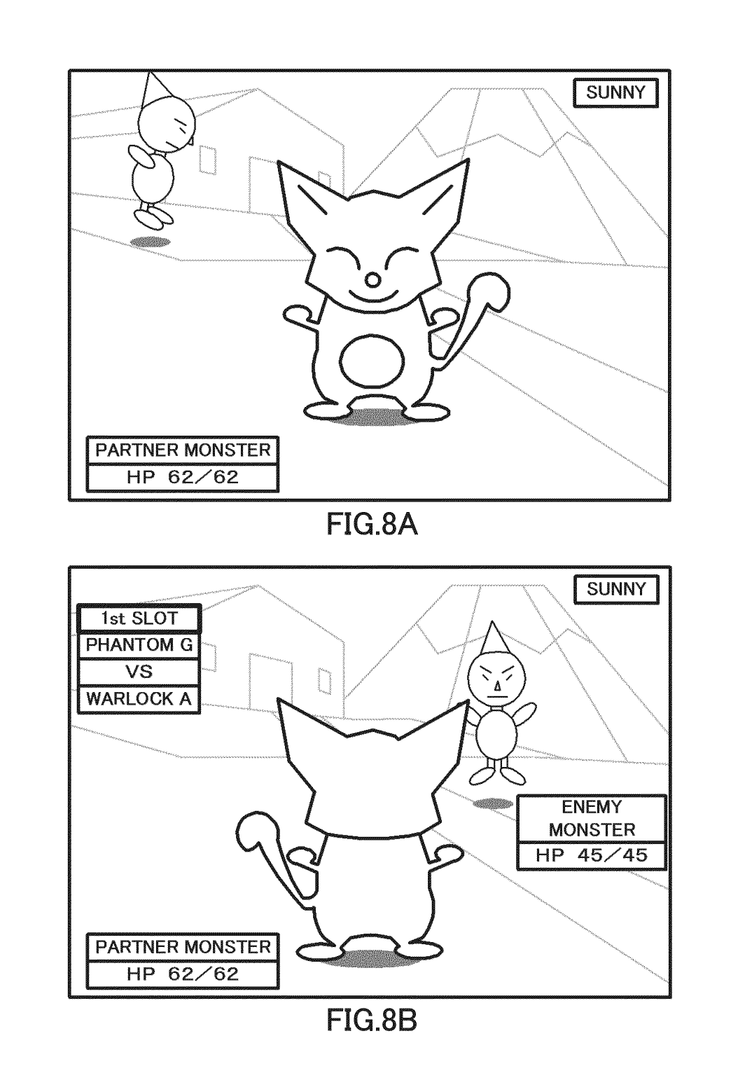

For example, the image generator 160 generates, in accordance with each object information stored in the game information memory 110 and the instruction (operation instruction) received by the operation receiver 120, a field image illustrated in FIG. 8A. That is, a game image having the partner monster character or the like moving in accordance with the operation given by the user is generated.

The image generator 160 generates, in accordance with, for example, each object information stored in the game information memory 110, a match-up control by the match-up controller 150, a match-up image illustrated in FIG. 8B. That is, the image generator 160 successively generates images of the battle of the monster characters controlled by the match-up controller 150 based on both partner and enemy time tables.

The image generator 160 generates a setting image for setting a time table prior to the start of the battle. That is, the image generator 160 generates the above-explained setting images illustrated in FIGS. 5A to 5C in accordance with, for example, respective symbols and icons stored in the game information memory 110, and the setting status by the setter 130.

The image generator 160 displays the game images (field image and match-up image) illustrated in FIGS. 8A and 8B on the above-explained first display 18, while at the same time, displays the setting images illustrated in FIGS. 5A to 5C on the above-explained second display 19. The image generator 160 displays the setting images on the second display 19 in such a way that the user is capable of operating the setting images through the touch panel 20.

The above-explained image processor 10b serves as such an image generator 160.

Returning to FIG. 3, the determiner 170 determines a win or a loss for the user (the player character) based on a result of the match-up control by the match-up controller 150.

For example, during the battle between the partner and enemy monster characters controlled by the match-up controller 150 based on the respective time tables, when the HP of either monster character becomes zero, the determiner 170 determines the win and loss for the respective monster characters. That is, the determiner 170 determines that the monster character having the value of HP becoming zero as a loser, and the monster character having the value of HP left as a winner.

The determiner 170 updates information stored in the game information memory 110 as needed based on the determination result.

When, for example, the partner monster character wins, the determiner 170 performs an update in such a manner as to increase the experience points and possessed money of the partner monster character or the like stored in the game information memory 110. Conversely, when the partner monster character loses, the determiner 170 performs update in such a manner as to, for example decrease the possessed money of the partner monster character or the like by half. The update target at the time of winning and losing is optional, and can be changed accordingly.

The above-explained CPU core 10a and the like serve as such a determiner 170.

### Operation of Gaming Apparatus

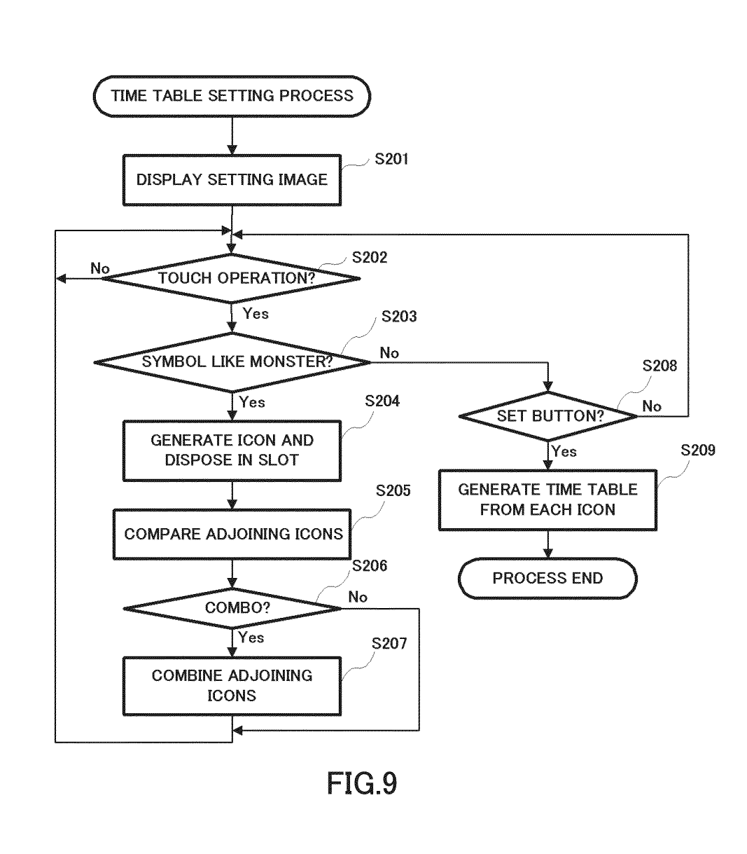

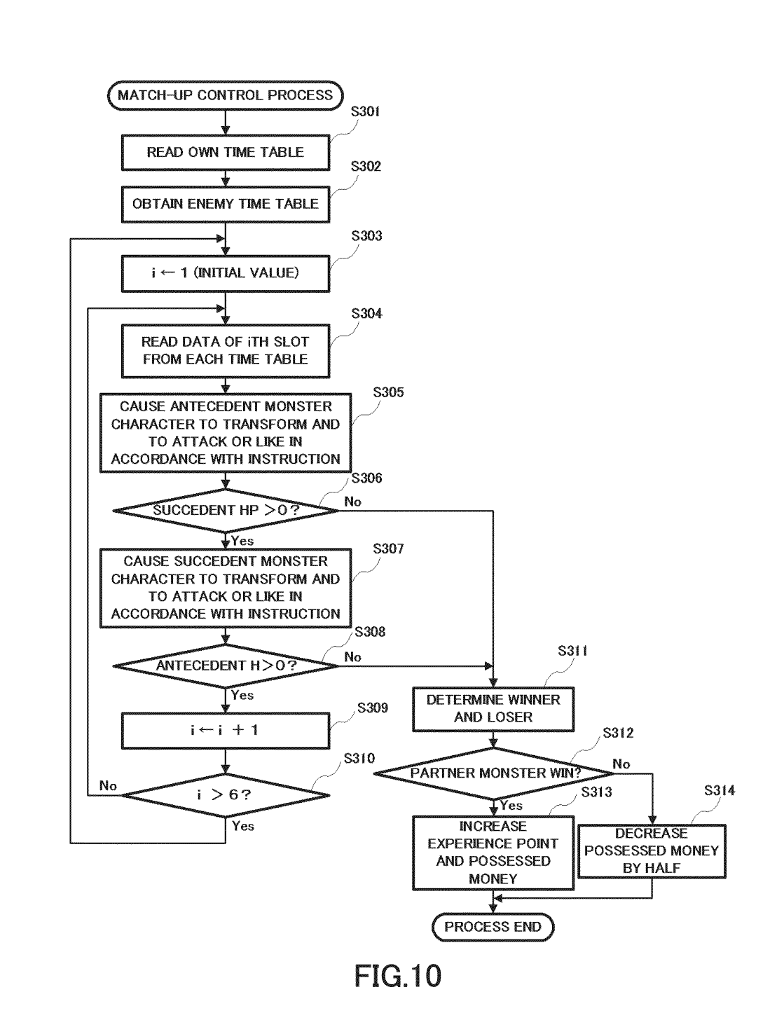

An explanation will be below given of an operation of the gaming apparatus 100 employing the above-explained structure with reference to the accompanying drawings. FIG. 9 is a flowchart illustrating an example time table setting process executed by the gaming apparatus 100 according to the first embodiment of the present invention. FIG. 10 is a flowchart illustrating an example match-up control process executed by the gaming apparatus 100.

First, a time table setting process will be explained with reference to FIG. 9. The time table setting process is started when the partner monster character or the like moving in the game field encounters an enemy monster character.

The gaming apparatus 100 displays the setting image for setting a time table (step S201).

More specifically, the image generator 160 displays the above-explained setting image illustrated in FIG. 5A on the second display 19. That is, the image generator 160 displays the setting image containing the time table setting area TSA, the set button KB, and the monster selecting area MSA in a manner operable through the touch panel 20.

The gaming apparatus 100 determines whether or not a touch operation has been given (step S202). That is, the operation receiver 120 determines whether or not the touch panel 20 is depressed by a touch pen or the like.

When determining that no touch operation has been given (step S202: NO), the gaming apparatus 100 repeats a determination on a touch operation.

Conversely, when determining that a touch operation is given (step S202: YES), the gaming apparatus 100 determines whether or not such a touch operation is given to the symbol of a monster or the like (step S203).

More specifically, the setter 130 determines whether or not the touch operation is given within the monster selecting area MSA illustrated in FIG. 5A. That is, the setter 130 determines whether or not a selection operation of each monster symbol MS and each command symbol CS in the monster selecting area MSA is given.

When determining that the touch operation is given to a symbol like a monster (step S203: YES), the gaming apparatus 100 generates an icon corresponding to such a touch operation, and dispose the generated icon in the slot (step S204).

When, for example, the monster symbol MS 1 and the command symbol CS 1 therebelow are selected through the touch operation as illustrated in FIG. 5B, the setter 130 generates the icon IC1 combining those symbols, and dispose the generated icon IC1 in the slot ST in the time table setting area TSA.

At this time, the image generator 160 successively generates (updates) setting images in accordance with a touch operation given by the user and the layout of the icons IC by the setter 130. That is, the image generator 160 successively updates the setting image in accordance with a touch operation by the user or the like as illustrated in FIGS. 5B and 5C, and displays the updated image on the second display 19.

It is omitted in the following explanation but the image generator 160 keeps generating (updating) such a setting image in accordance with a touch operation by the user and the layout of the icons IC by the setter 130 (including, for example, a combination of icons).

The gaming apparatus 100 compares the adjoining icons disposed in the slots (step S205).

That is, the setter 130 compares the currently disposed icon IC and the icon IC disposed right before (previous time) in the time table setting area TSA.

For example, as illustrated in FIG. 6A explained above, when the icon IC4 is disposed this time following the icon IC3 disposed the previous time, the setter 130 compares those adjoining icons IC3 and IC4.

However, when the icon IC is presently disposed at the first time slot in the time table setting area TSA, there is no comparison target, and thus the gaming apparatus 100 directly returns the process to the step S202.

The gaming apparatus 100 determines whether or not there is a combo skill based on the compared adjoining icons (step S206).

That is, the setter 130 determines whether or not the relationship between the compared adjoining icons IC, that is, a relationship between the monster character selected before and the instruction thereof, and, the monster character selected after and the instruction thereof, is defined as a combo skill. As explained above, when such a combo skill is not used (not activated) at all in the former actual battle, the combo skill is kept in secret. Hence, in the non-activated condition, such a relationship is determined as not defined as a combo skill. That is, such a relationship is determined as a combo skill only after the combo skill has been activated.

When determining that the adjoining icons are not defined as a combo skill (step S206: NO), the gaming apparatus 100 returns the process to the above-explained step S202.

Conversely, when the adjoining icons are determined as being defined as a combo skill (step S206: YES), the gaming apparatus 100 combines those adjoining icons (step S207).

More specifically, when the adjoining icons IC3 and IC4 illustrated in FIG. 6A are defined as a combo skill (already activated), the setter 130 replaces those icons with the icon IC5 combining those icons as illustrated in FIG. 6B.

When the icons are combined, the number of used slots increases or decreases in some cases. When, for example, the above-explained adjoining icons IC6 and IC7 illustrated in FIG. 6C are defined as a combo skill (already activated), the setter 130 replaces those icons with the above-explained icon IC8 combining those icons as illustrated in FIG. 6B. At this time, the number of slots of the icon IC8 combining those icons (two slots) decreases the number of slots of the icons IC6 and IC7 (three slots) before the combination.

The gaming apparatus 100 returns the process to the above-explained step S202.

In the above-explained step S203, when determining that the touch operation has not given to the symbol like a monster (step S203: NO), the gaming apparatus 100 determines whether or not such a touch operation has been given to the set button (step S208).

More specifically, the setter 130 determines whether or not a touch operation has been given to the set button KB illustrated in FIG. 5A and the like. That is, the setter 130 determines whether or not a touch operation has been given to the set button KB for setting the setting of the time table.

When determining that the touch operation has not given to the set button (step S208: NO), the gaming apparatus 100 returns the process to the above-explained step S202. For example, when such a touch operation has been given to a position not subjected to an operation like a blank space, the gaming apparatus 100 executes no process, and returns the process to the step S202, thereby repeating a determination on a touch operation.

It is omitted in the flowchart but when such a touch operation is given to another operation target, the gaming apparatus 100 executes a process accordingly in accordance with the touch operation. When, for example, the touch operation is given to the icon IC already disposed in the time table setting area TSA, the setter 130 corrects the icon IC, that is, re-selection of the monster symbol MS and the command symbol CS.

Conversely, when determining that the touch operation has been given to the set button (step S208: YES), the gaming apparatus 100 generates a time table from each icon (step S209).

That is, the setter 130 generates the above-explained time table TL illustrated in FIG. 4 in accordance with each icon IC disposed in the time table setting area TSA, and stores the generated time table in the game information memory 110. That is, the setter 130 converts each icon IC into the identification information (monster ID) of the monster character and the identification information (command ID) of the command, and sets those pieces of identification information in each slot of the time table TL.

The gaming apparatus 100 completes the time table setting process.

The time table setting process enables the user to select a monster character and the like arbitrarily, and to set the selected monster character and the like in the time table. That is, in consideration of the force, attribute, and the like of the enemy monster character or the like that is a match-up competitor, a monster character and an instruction counteracting against those properties are set in the time table. More specifically, the user plans a tactic for a battle with an enemy monster character, and sets a battle procedure in the time table in accordance with the planned tactic.

Next, with reference to FIG. 10, an explanation will be given of the match-up control process. The match-up control process successively starts after the above-explained time table setting process illustrated in FIG. 9 completes.

The gaming apparatus 100 reads the own time table (step S301). That is, the match-up controller 150 reads the time table TL illustrated in FIG. 4 and stored in the game information memory 110 (set by the setter 130).

The gaming apparatus 100 obtains the enemy time table (step S302). That is, the obtainer 140 obtains the time table of a match-up competitor (enemy monster character).

When, for example, the user plays this game in solo, the obtainer 140 generates a time table accordingly in accordance with the predetermined logic and the like, and obtains this time table as the time table of the enemy monster character.

Conversely, when the user plays the game so as to be able to have a match-up with another user, the obtainer 140 obtains the time table of the enemy monster character transmitted from another gaming apparatus 100 (the gaming apparatus 100 corresponding to the encountered enemy monster character) through the wireless communicator 13 and the like.

The gaming apparatus 100 sets a variable i for managing the advancement of a battle to be 1 that is an initial value (step S303).

That is, the match-up controller 150 sets the variable i for managing the current slot to be 1 for causing both monster characters to fight against each other for each slot using the respective time tables of the partner and the enemy.

The gaming apparatus 100 reads data of a slot i from each time table (step S304).

That is, the match-up controller 150 reads respective data set in the ith slot from both partner and enemy time tables.

More specifically, when, for example, the variable i is 1, as illustrated in FIG. 7A, the match-up controller 150 reads a monster character (warlock A) and an instruction thereof (thunder) set in the first slot from the own time table TL1. Next, the match-up controller 150 reads a monster character (phantom G) and an instruction thereof (snowstorm) set in the first slot from the enemy time table TL2.

When the variable i is 2, likewise, as illustrated in FIG. 7B, the match-up controller 150 reads a monster character (beast B) and an instruction thereof (flame) set in the second slot from the own time table TL1. Next, the match-up controller 150 reads a monster character (dragon H) and an instruction (flame) set in the second slot from the enemy time table TL2.

The gaming apparatus 100 causes the antecedent monster character to transform, and to attack the competitor in accordance with the instruction or the like (step S305).

For example, the match-up controller 150 first decides the antecedent and the succedent based on the information on the partner monster character and the information on the enemy monster character. As an example way of setting the antecedent and the succedent, such antecedent and succedent are set based on experience points of both monster characters and other information (for example, the rating of speed), and the setting is maintained during the successive battles (all slots) of the present time. How to set the antecedent and the succedent is optional, and can be changed as needed. The antecedent and the succedent may be set for each slot. For example, a random number may be generated for each slot and for each time, and the antecedent and the succedent may be set based on the value of such a random number.

The match-up controller 150 causes the antecedent to transform into the read monster character and to attack or the like the competitor in accordance with the read instruction after the antecedent and the succedent are set (or are set already). For example, as illustrated in FIG. 7A, with the data of the first slot being read, when the antecedent is the partner (time table TL1), the match-up controller 150 causes the partner monster character to transform into the warlock A, and to attack the enemy monster character with thunder.

The match-up controller 150 calculates the damage of the succedent on which the attack was made, and subtracts a value by what corresponds to such a damage from the HP of the succedent stored in the game information memory 110. When the HP becomes a negative value by the subtraction, the HP is not set to be a negative value but is set to be zero.

At this time, the image generator 160 successively generates (updates) match-up images in accordance with a transform and an attack. For example, the image generator 160 successively updates the match-up image illustrated in FIG. 8B to an image expressing that the antecedent is transformed into a monster character, an image expressing that the antecedent attacks the succedent, and the image expressing that the succedent receives an amount of damage, and displays the images on the first display 18.

It is omitted in the following explanation but the image generator 160 keeps generating (updating) the match-up image in accordance with the match-up control by the match-up controller 150.

The gaming apparatus 100 determines whether or not the HP of the succedent monster character is greater than zero (step S306).

That is, the match-up controller 150 determines whether or not the HP of the succedent monster character on which the attack or the like was made has any remaining points.

When determining that the HP of the succedent monster character is greater than zero (step S306: YES), the gaming apparatus 100 causes the succedent monster character to transform, and to attack the competitor in accordance with the instruction (step S307).

That is, the attack and defense turns are inverted. That is, the match-up controller 150 causes the succedent to transform into the read monster character, and to attack or the like the competitor in accordance with the read instruction. For example, as illustrated in FIG. 7A, with the data of the first slot being read, when the enemy (time table TL2) is the succedent, the enemy monster character is caused to transform into the phantom G, and to attack the partner monster character with snowstorm.

The match-up controller 150 calculates a damage of the antecedent on which the attack was made, and subtracts the value by what corresponds to such a damage from the HP of the antecedent. When the HP becomes a negative value by the subtraction, the match-up controller 150 does not set the HP to be a negative value but sets the HP to be zero.

The gaming apparatus 100 determines whether or not the HP of the antecedent monster character is greater than zero (step S308).

That is, the match-up controller 150 determines whether or not the HP of the antecedent monster character on which the attack was made has any remaining points.

The gaming apparatus 100 adds 1 to the variable i (step S309) when determining that the HP of the antecedent monster character is greater than zero (step S308: YES).

The gaming apparatus 100 determines whether or not the variable i after the addition is greater than 6 (step S310). That is, the gaming apparatus 100 determines whether or not the battle up to the sixth slot has completed.

When determining that the variable i is equal to or less than 6 (step S310: NO), the gaming apparatus 100 returns the process to the above-explained step S304, and repeats the battle of the following slot i. Conversely, when determining that the variable i is greater than 6 (step S310: YES), the gaming apparatus 100 returns the process to the above-explained step S303, and repeats the battle in a sequential order from the first slot.

When determining that the HP of the monster character (succedent or antecedent) on which the attack was made in the above-explained step S306 or S308 is zero (step S306, step S308: NO), the gaming apparatus 100 determines the winner and the loser (step S311).

That is, the determiner 170 determines the winner and the loser based on which one of the partner and enemy monster characters has zero HP. That is, the determiner 170 sets the monster character having zero HP as a loser and sets the monster character having positive HP as a winner.

The gaming apparatus 100 determines whether or not the partner monster character is the winner (step S312).

That is, the determiner 170 determines whether or not the HP of the partner monster has any remaining points, the HP of the enemy monster has reached zero, and the partner monster character is the winner.

When determining that the partner monster character is the winner (step S312: YES), the gaming apparatus 100 increases the experience points and the possessed money (step S313). That is, the determiner 170 increases and updates accordingly the experience point sand possessed money of the partner monster character or the like stored in the game information memory 110. The update target data at the time of winning a battle is optional, and can be changed as needed.

Conversely, when determining that the partner monster character has lost (the enemy monster character is the winner) (step S312: NO), the gaming apparatus 100 decreases the possessed money by half (step S314). That is, the determiner 170 performs an update such as decreasing the possessed money of the partner monster character or the like stored in the game information memory 110 by half. The update target data at the time of losing a battle is optional and can be changed as needed.

The match-up control process enables both partner and enemy monster characters to fight against each other in accordance with both time tables. That is, the partner monster character attacks or the like the enemy character based on the time table set by the user, while the enemy monster character attacks or the like the partner monster character based on the time table set by another user (or the CPU core 10a). Hence, the user is capable of enjoying the successive battles including whether or not the tactic planned by the user was effective against the enemy monster character.

### Second Embodiment

In the first embodiment, the explanation was given of the case in which each battle is controlled in accordance with the set time table exactly, but the player character (the user) may intervene any time during a battle.

An explanation will be below given of a gaming apparatus 100 according to a second embodiment of the present invention which has a feature of allowing the user to give a new instruction (intervening operation) to a monster character waiting for a battle even after the battle has started.

The gaming apparatus 100 of the second embodiment of the present invention employs the same structure as that of the gaming apparatus 100 of the first embodiment illustrated in FIG. 3.

However, the game information memory 110, the operation receiver 120, the match-up controller 150, and the image generator 160 further have following features.

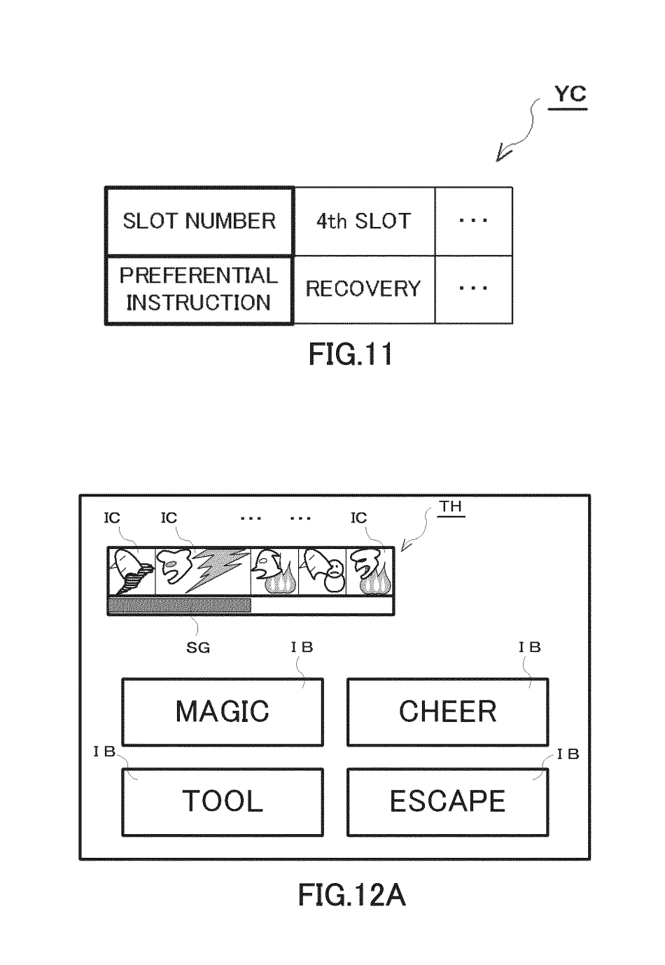

The game information memory 110 further stores preferential instruction information YC as illustrated in FIG. 11. The preferential instruction information YC indicates a preferential instruction to a slot (a monster character waiting for a battle) not executed yet on the time table TL. More specifically, the preferential instruction information YC instructs a recovery of the HP as a preferential instruction when the battle advances in accordance with the tactic (that is, the time table TL) initially set by the user but the partner monster character is on the back foot contrary to the user's expectation (for example, the remaining HP becomes low).

The content of the preferential instruction can be changed as needed. For example, the content of the preferential instruction may be the use of a tool, an escape (termination of battle) or the like. In FIG. 11, the preferential instruction is indicated by an appellation, but this is to facilitate understanding, and in practice, the identification information (command ID or the like) of the instruction is stored.

The preferential instruction information YC is set based on an intervening operation received during the battle through the following operation receiver 120.

The operation receiver 120 is capable of receiving a predetermined operation given by the user after a battle starts. That is, the operation receiver 120 is capable of receiving an intervening operation for a monster character waiting for a battle on the time table TL. The detail of the intervening operation will be explained later together with the image generator 160.

When a battle starts, the image generator 160 generates an in-battle operation image that enables an intervening operation. That is, the image generator 160 generates an in-battle operation image in parallel with a generation of the match-up image illustrated in FIG. 8B. The image generator 160 displays the generated in-battle operation image on the second display 19 in a manner operable through the touch panel 20.

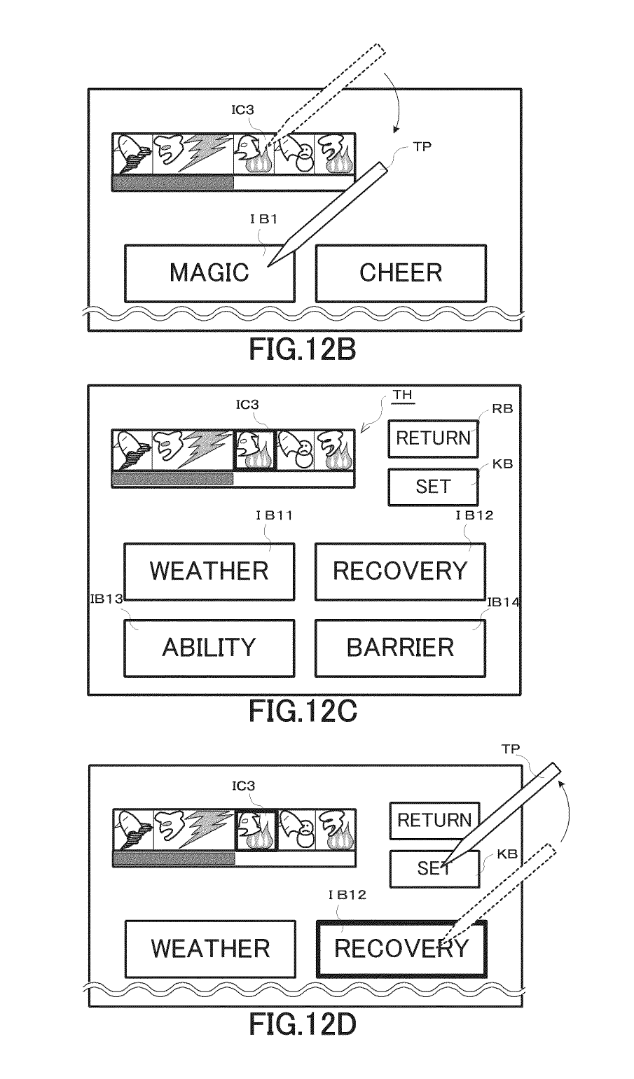

More specifically, the image generator 160 generates an in-battle operation image as illustrated in FIG. 12A. The example in-battle operation image contains a time table display TH, multiple intervention buttons IB, and the like.

The time table display TH indicates the content of the own time table and the progress of the battle. With respect to the content of the time table, the content of the battle (monster character and instruction thereof) set in each slot is indicated by the icon IC based on the time table TL stored in the game information memory 110. Conversely, the progress of the battle indicates up to which slot the battle has currently advanced through a progress gauge SG. The icon IC reached by the progress gauge SG (icon IC on progress gauge SG) is out of the target of an intervening operation, and may be changed to, for example, a gray color display.

Each intervention button IB indicates the content of the intervening operation permitted to the user. Each intervention button IB in FIG. 12A indicates the highest content (for example, classification) of the intervening operation, and the specific content of the intervening operation is associated with a lower classification. That is, when any of the intervention buttons IB is operated, another intervention button IB indicating the specific content of the intervening operation as the lower classification is likewise displayed.

A specific explanation will be given of an intervening operation with the operation screen in a battle being displayed on the second display 19.

As an example, as illustrated in FIG. 12 B, when the user operates the touch pen TP and the icon IC 3 and an intervention button D31 (magic) are depressed, the operation receiver 120 receives those intervening operations through the touch panel 20. That is, the operation receiver 120 receives a monster character or the like set in the slot subjected to an intervention and the content of an intervening instruction (in this example, a classification or the like). The slots that permit an intervening operation are limited to only the slots where no progress gauge SG has reached yet. That is, a preferential instruction is permitted only to a monster character (icon IC) waiting for a battle. Accordingly, when the icon IC where the progress gauge SG has already reached is selected, for example, a predetermined error sound is output, and the operation receiver 120 may skip such operation.

As explained above, the specific content of the intervening operation is associated with the lower classification of the intervention button IB1. Accordingly, the image generator 160 generates an in-battle operation image as illustrated in FIG. 12C. This in-battle operation image has the time table display TH remained as it is, but intervention buttons IB 11 to IB 14 (lower classifications of the intervention button IB1), a return button RB, and the set button KB are changed.

As an example, as illustrated in FIG. 12D, when the user operates the touch pen TP, and an intervention button IB 12 (recovery) and the set button KB are depressed, the operation receiver 120 receives such intervening operations through the touch panel 20. That is, the operation receiver 120 receives a recovery instruction and sends it to the fourth slot (icon IC3), sets the slot and the instruction in the above-explained preferential instruction information YC illustrated in FIG. 11, and stores the set content in the game information memory 110.

The match-up controller 150 controls the battle of both monster characters based on the respective partner and enemy time tables and the preferential instruction information YC.

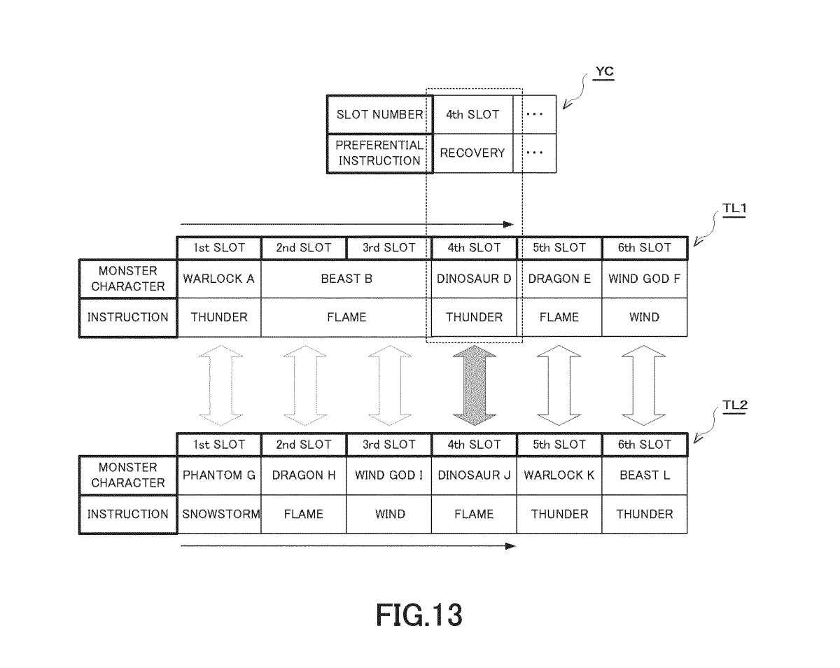

When, for example, the above-explained preferential instruction information YC illustrated in FIG. 11 is set through the intervening operation, the match-up controller 150 gives a preference to the preferential instruction (recovery) of the preferential instruction information YC rather than the instruction (thunder) in the time table TL1 in the battle of the fourth slot illustrated in FIG. 13. That is, in the fourth slot, the match-up controller 150 causes both monster characters to fight against each other based on the own time table TL1 (dinosaur D)+preferential instruction (recovery) and the enemy time table TL2 (dinosaur J and flame).

The preferential instruction may be set so as not to be accepted in some cases. That is, even if the preferential instruction information YC is set through the above-explained intervening operation, the preferential instruction may be rejected at a predetermined percentage or the like. For example, the match-up controller 150 rejects the preferential instruction at a predetermined percentage or the like based on the value of a whimsy of the partner monster character, a random number, and the like, and causes the monster character to attack or the like the enemy character directly with the instruction in the time table TL1.

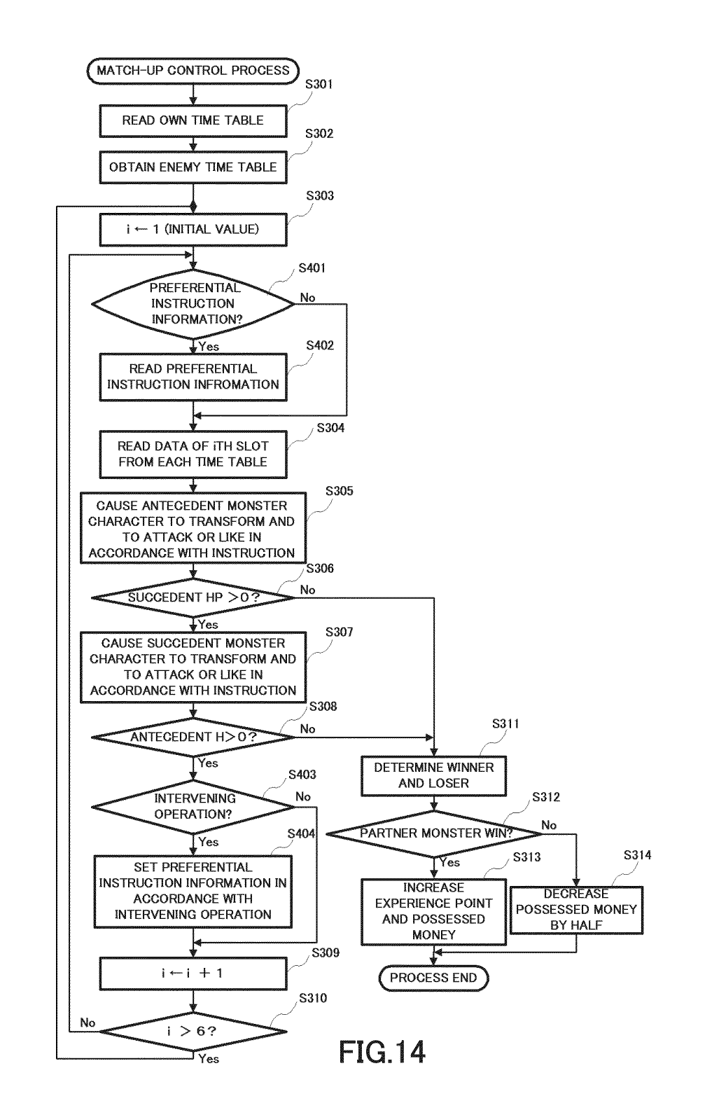

An explanation will be given of an operation of the gaming apparatus 100 that enables an intervening operation with reference to the accompanying drawings. FIG. 14 is a flowchart illustrating an example match-up control process executed by the gaming apparatus 100 according to the second embodiment of the present invention. The match-up control process successively starts after the time table setting process (see FIG. 8) completes likewise the above-explained first embodiment.

In the match-up control process in FIG. 14, the same process content as that of the match-up control process (see FIG. 9) in the above-explained first embodiment is denoted by the same reference numeral.

The gaming apparatus 100 reads the own time table (step S301), and obtains the enemy time table (step S302).

The gaming apparatus 100 sets the variable i for managing the progress of the battle to be 1 that is the initial value (step S303).

The gaming apparatus 100 determines whether or not the preferential instruction information is set (step S401). That is, the gaming apparatus 100 determines whether or not the preference instruction information YC as illustrated in FIG. 11 is stored in the game information memory 110. In other words, the gaming apparatus 100 determines whether or not an intervening operation is given after the battle starts.

When determining that no preferential instruction information is set (step S401: NO), the gaming apparatus 100 progresses the process to step S304 to be discussed later.

Conversely, when determining that the preferential instruction information is set (step S401: YES), the gaming apparatus 100 reads the preferential instruction information YC from the game information memory 110 (step S402).

The gaming apparatus 100 reads data for a slot i from each time table (step S304).

The gaming apparatus 100 causes the antecedent monster character to transform, and to attack or the like the competitor in accordance with the instruction (step S305).

At this time, when the preferential instruction information YC is read in the above-explained step S402 and the partner monster character is the antecedent, the preference is given to the preferential instruction information YC rather than the instruction in the time table TL1. The detail of the process when the preferential instruction is processed will be explained again after the process of an intervening operation is explained later.

The gaming apparatus 100 determines whether or not the HP of the succedent monster character is greater than zero (step S306).

When determining that the HP of the succedent monster character is greater than zero (step S306: YES), the gaming apparatus 100 causes the succedent monster character to transform, and to attack the competitor in accordance with the instruction (step S307).

At this time, when the preferential instruction information YC is read in the above-explained step S402 and the partner monster character is the succedent, the gaming apparatus 100 gives a preference to the preferential instruction of the preferential instruction information YC rather than the instruction in the time table TL1. The detail of the process of processing the preferential instruction will be explained again after the process of the intervening operation is explained later.

The gaming apparatus 100 determines whether or not the HP of the antecedent monster character is greater than zero (step S308).

When determining that the HP of the antecedent monster character is greater than zero (step S308: YES), the gaming apparatus 100 determines whether or not an intervening operation is given (step S403).

That is, with the image generator 160 generating the in-battle operation image illustrated in FIG. 12A and displaying such an image on the second display 19, the operation receiver 120 determines whether or not an operation given by the user is received. Each intervention button IB in FIG. 12A indicates the highest content (classification) of the intervening operation, and the specific classification of the permitted intervening operation is associated with the lower classification.

When determining that no intervening operation has been given (step S403: NO), the gaming apparatus 100 progresses the process to step S309 to be discussed later.

When determining that an intervening operation has been given (step S403: YES), the gaming apparatus 100 sets preferential instruction information in accordance with the given intervening operation (step S404).

When, for example, the user operates the touch pen TP and depresses the icon IC3 and the intervention button IB 1 (magic) as illustrated in FIG. 12B, the operation receiver 120 receives the contents of those instructions (in this case, classification or the like) through the touch panel 20. At this time, the slots that permit the intervening operation are limited to only the slots where no progress gauge SG has reached, and when the icon IC where the progress gauge SG has reached is selected, for example, a predetermined error sound is output, and the operation receiver 120 skips this operation.

The specific content of the intervening operation is associated with the lower classification of the intervening button IB1, and the image generator 160 generates the in-battle operation image illustrated in FIG. 12C.

As illustrated in FIG. 12D, when the user operates the touch pen TP and depresses the intervention button IB 12 (recovery) and the set button KB, the operation receiver 120 receives that intervening operation through the touch panel 20. That is, the operation receiver 120 receives a recovery instruction to the fourth slot (icon IC3), sets the slot and the instruction in the preferential instruction information YC illustrated in FIG. 11, and stores the set information in the game information memory 110.

The gaming apparatus 100 adds 1 to the variable i (step S309), and determines whether or not the variable i after the addition is greater than 6 (step S310).

When determining that the variable i is equal to or less than 6 (step S310: NO), the gaming apparatus 100 returns the process to the above-explained step S304, and repeats the battle of the following slot i. Conversely, when determining that the variable i is larger than 6 (step S310: YES), the gaming apparatus 100 returns the process to the above-explained step S303, and repeats the battle in a sequential order from the first slot.

When the preferential instruction information is set in the above-explained step S404, and at the time of the attack by the partner monster character in either one of the above-explained steps S305 and S307, the match-up controller 150 controls the battle of both monster characters in consideration of the preferential instruction information.

When, for example, the preferential instruction information YC illustrated in FIG. 11 is set, in the battle of the above-explained fourth slot illustrated in FIG. 13, the match-up controller 150 gives a preference to the preferential instruction (recovery) of the preferential instruction information YC rather than the instruction (thunder) in the time table TL1. That is, in the fourth slot, the match-up controller 150 causes both monster characters to fight against each other based on the own time table TL1 (dinosaur D)+preferential instruction (recovery) and the enemy time table TL2 (dinosaur J and flame).

As explained above, such a preferential instruction may be not always accepted. That is, even if the preferential instruction information YC is set through the above-explained intervening operation, the preferential instruction may be rejected at a predetermined percentage or the like. For example, the match-up controller 150 rejects the preferential instruction at a predetermined percentage or the like based on the value of the whimsy of the partner monster character, a random number, and the like, and causes the partner monster character to attack with the instruction in the time table TL1.

When determining that the HP of the monster character to which an attack was made in the above-explained steps S306 and S308 is zero (steps S306 and S308: NO), the gaming apparatus 100 determines the winner and the loser (step S311).

The gaming apparatus 100 determines whether or not the partner monster character is the winner (step S312), and when determining that the partner monster character is the winner (step S312: YES), the gaming apparatus 100 increases the experience point and the possessed money (step S313).

Conversely, when determining that the partner monster character is the loser (the enemy monster character is the winner) (step S312: NO), the gaming apparatus 100 decreases the possessed money by half (step S314).

The match-up control process permits the user to intervene while the battle is carried out in accordance with the time tables of the partner and enemy time tables. For example, when the battle is advanced in accordance with the tactic (that is, the time table TL) initially planned by the user but the tactic works negatively, it is possible to give a preferential instruction to a partner monster character waiting for a battle through an intervening operation. Accordingly, the user does not view the progress of the battle indefinitely, but observes the battle with a feeling of tension so that the user can give an intervening operation in any time in accordance with the tactical situation.

In the above-explained second embodiment, the explanation was given of the case in which the preferential instruction by the intervening operation is executed instead of the slot (the specified slot), but the preferential instruction may be executed (activated) additionally with the content of the slot being left as it is.

For example, the intervening operation is basically permitted until the end of the battle (other than a case in which an MP or the like necessary for the intervening operation is insufficient and a magic or the like is applied which enables an intervening operation), and may be activated during a transition from the completion of the slot in the own time table to next slot.

More specifically, a preferential instruction through an intervening operation which makes a selection of the icon IC (IC3) illustrated in FIG. 12B unnecessary and which is given before the progress gauge SG reaches the next slot is activated during a transition from the completion of the current slot to the next slot. When, for example, the preferential instruction YC illustrated in FIG. 13 is set through an intervening operation during the execution of the fourth slot, the match-up controller 150 executes the preferential instruction (recovery) of the preferential instruction information YC after the battle of the fourth slot and before the transition to the fifth slot.

In the above-explained second embodiment, the explanation was given of the case in which the preferential instruction is rejected at a predetermined percentage or the like, but the preferential instruction may be always executed but the content set in the time table may be rejected instead at a predetermined percentage or the like.

### Third Embodiment

In the above-explained first and second embodiments, the explanation was given of a match-up in a role playing game, but a match-up with another user (another gaming apparatus) may be enabled regardless of the progress of the game.

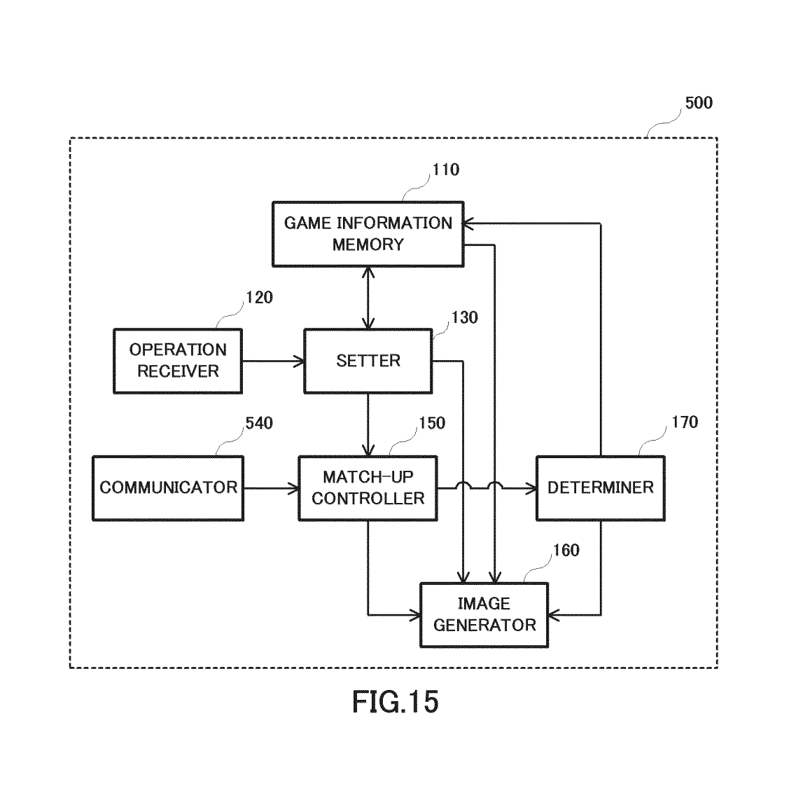

An explanation will be given of a gaming apparatus 500 according to a third embodiment of the present invention which has a feature of exchanging (transmitting and receiving) time tables through a wireless communication to enable a match-up with an unknown competitor regardless of the progress of the game with reference to FIG. 15.

As illustrated in FIG. 15, the gaming apparatus 500 includes the game information memory 110, the operation receiver 120, the setter 130, a communicator 540, the match-up controller 150, the image generator 160, and the determiner 170.

That is, the respective components other than the communicator 540 are the same as those of the above-explained gaming apparatus 100 illustrated in FIG. 3 are denoted by the same reference numeral.

The game information memory 110, the match-up controller 150 and the determiner 170 perform further operations to be discussed later.

The communicator 540 establishes a communication with another gaming apparatus 500 present near the local gaming apparatus 500, and exchanges time tables therewith.

More specifically, when the role playing game played by the user enters a standby state (as an example, the screen is closed with the power being turned on and the gaming apparatus 500 enters a suspended state), the communicator 540 successively attempts to establish a wireless communication with another gaming apparatus 500 (the gaming apparatus 500 likewise in the standby state in the same role playing game). For example, the communicator 540 successively transmits a reply request containing the identification information (for example, a unique device number) of the gaming apparatus 500 and the identification information (for example, a game ID) of the role playing game for each predetermined timing. Another gaming apparatus 500 that has received this reply request compares the game ID and the like, and replies response information when the same role playing game is in the standby state or the like.

A communication is enabled between the gaming apparatuses 500 throughout this information exchange, the communicator 540 reads the above-explained time table TL illustrated in FIG. 4 from the game information memory 110, and transmits the read time table to another gaming apparatus 500. Each gaming apparatus 500 receives the time table transmitted from another gaming apparatus 500, and stores the received time table in the game information memory 110.

The above-explained wireless communicator 13, communication controller 14, and the like serve as such a communicator 540.

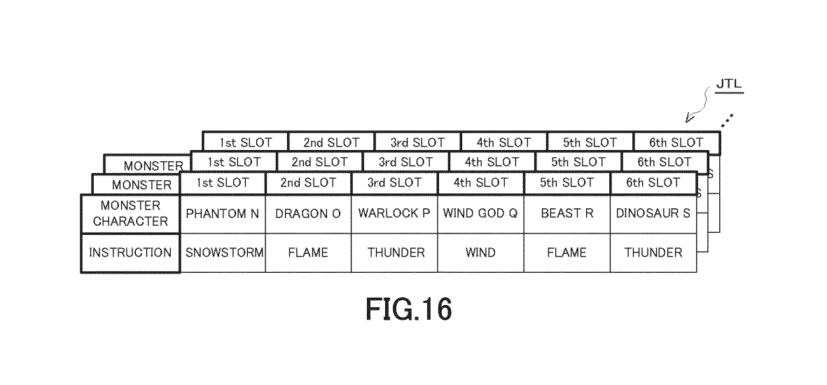

The game information memory 110 further stores a received time table JTL illustrated in FIG. 16.

That is, the game information memory 110 adds the time table received from another gaming apparatus 500 by the above-explained communicator 540 to the received time table JTL and stores such a time table. When the number of time tables exceeds the upper limit number of timetables that can be stored in the received time table JTL, the newly received time table may be discarded or the time tables may be erased, oldest first, and the latest time table may be stored instead.

As will be discussed later, when the match-up controller 150 controls a match-up, data on the HP and the like of an enemy monster character corresponding to the received time table JTL are generated as needed so as to correspond to data on the HP and the like of the partner monster character. That is, a great difference in the advancement of the game (for example, the level of a partner monster character) is expected between the other gaming apparatuses 500 and in order to enable a match-up depending on only the time tables, the match-up controller 150 generates data on the HP and the like of the enemy side so as to be roughly even to those of the partner side.

As will be discussed later, the time table used for the match-up control by the match-up controller 150 is erased from the received time table JTL by the determiner 170.

When the gaming apparatus 500 returns from the suspended state, if the match-up controller 150 has received a time table transmitted from another gaming apparatus 500 (if the received time table JTL is stored in the game information memory 110), the match-up controller 150 controls a match-up between both partner and enemy monster characters based on the received time table and the local time table.

That is, the match-up controller 150 causes both monster characters to fight against each other based on the time table TL stored in the game information memory 110 and the received time table JTL (one time table). Prior to the start of the battle, the match-up controller 150 generates data on the HP and the like of the enemy monster character corresponding to the received time table JTL accordingly so as to be roughly even to the HP and the like of the partner monster character, and stores the generated data in the game information memory 110.

The specific match-up control is made likewise FIGS. 7A and 7B. That is, the match-up controller 150 causes both monster characters in the same slot to fight against each other in a sequential order from the first slot. The match-up controller 150 also calculates a damage made to a competitor at the time of an attack from the other monster character, and subtracts the value corresponding to that damage from the HP of the competitor stored in the game information memory 110.

The determiner 170 determines the winner and the loser between the partner and enemy monster characters based on a result of the match-up control by the match-up controller 150.

When, for example, during the battle between the partner and enemy monster characters controlled by the match-up controller 150 based on the time table TL and the received time table JTL, the HP of the either monster character reaches zero, the determiner 170 determines the winner and the loser. That is, the determiner 170 determines that the monster character having the value of the HP reaching zero is the loser, and the monster character having remaining HP is the winner.

The determiner 170 appropriately updates information stored in the game information memory 110 based on such a determination result.

When, for example, the partner monster character wins, the determiner 170 accordingly increases the value of medals or the like possessed by the partner monster character or the like. Conversely, when the partner monster character loses, the determiner 170 eliminates the most inexpensive item possessed by the partner monster character or the like. The update target data at the time of winning or losing is optional, and can be changed as needed. For example, a monster character of a loser's end may be given (copied) to the winner end at random.

The determiner 170 deletes the received time table JTL (one time table) used for the match-up control from the game information memory 110.

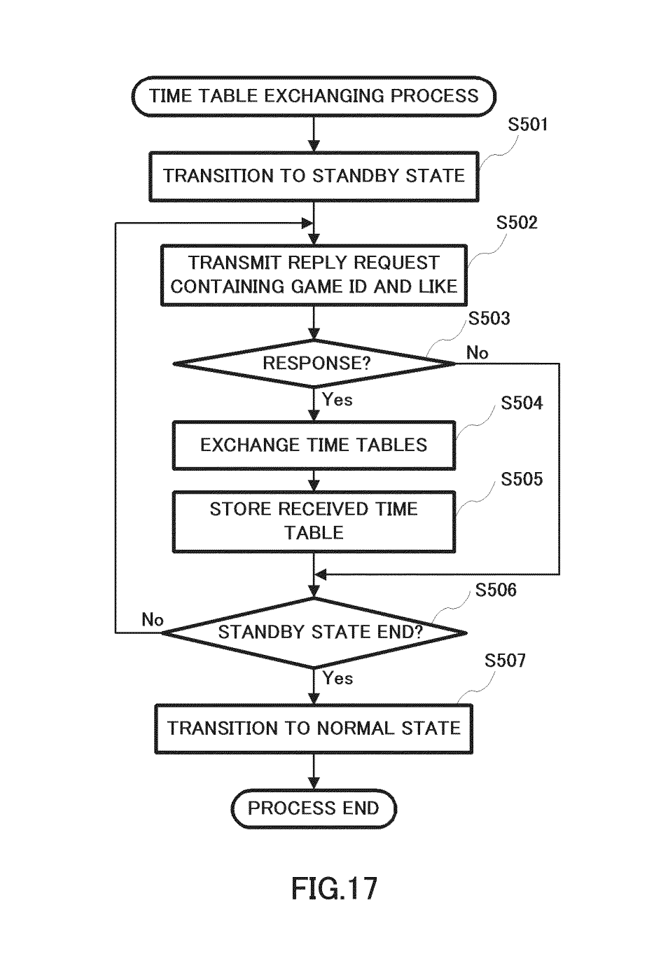

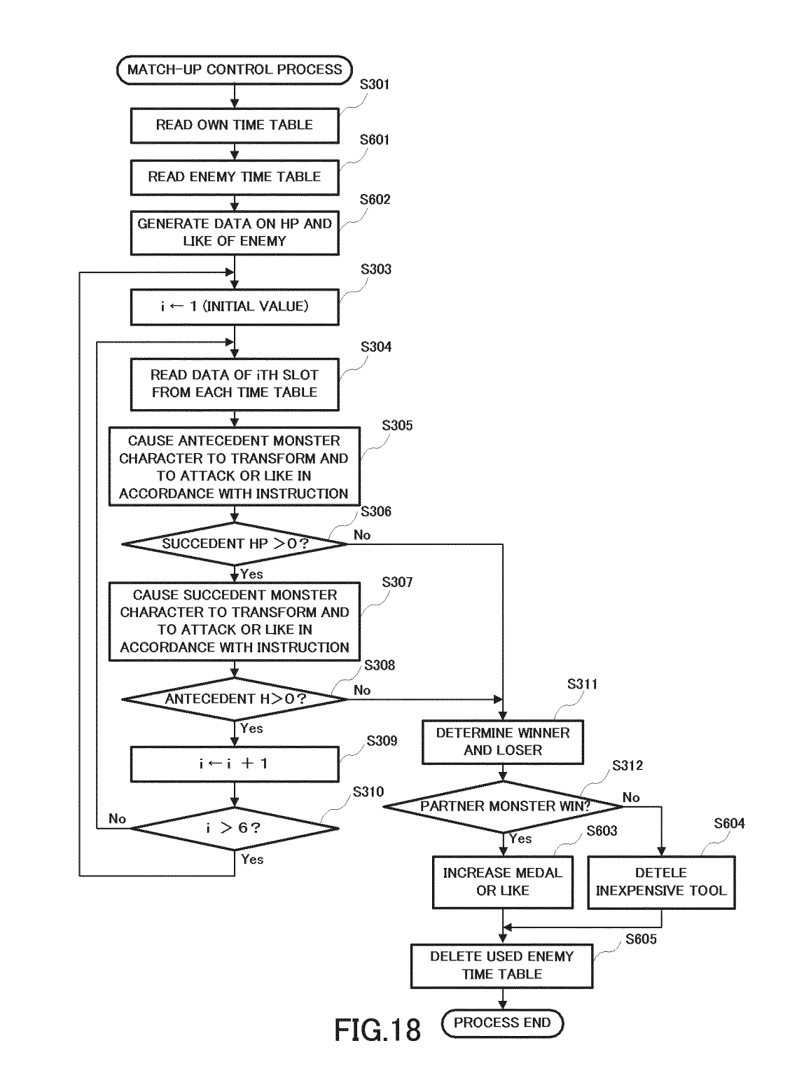

An explanation will be given below of an operation of the gaming apparatus 500 employing the above-explained structure with reference to drawings. FIG. 17 is a flowchart illustrating an example time table exchanging process executed by the gaming apparatus 500 according to the third embodiment of the present invention. FIG. 18 is a flowchart illustrating an example match-up control process executed by the gaming apparatus 500.

First, the time table exchanging process will be explained with reference to FIG. 17. As an example, this time table exchanging process starts when the screen (the above-explained upper casing JC) is closed while the power is turned on with the above-explained time table setting process illustrated in FIG. 9 being executed and the time table TL being stored in the game information memory 110.

The gaming apparatus 500 transitions to a standby state (step S501). For example, the gaming apparatus 500 which has been executing the role playing game transitions to the suspended state upon closing of the screen with the power being turned on. That is, when the above-explained open/closed sensor 21 detects that the upper casing JC is closed, the gaming apparatus 500 transitions to the suspended state.

The gaming apparatus 500 transmits a reply request containing the game ID and the like (step S502). That is, the communicator 540 transmits a reply request containing the game ID of the role playing game and the like to the nearby location in order to attempt a wireless communication with another gaming apparatus 500.

The gaming apparatus 500 determines whether or not there is a response (step S503). That is, when there is another gaming apparatus 500 near the local gaming apparatus 500 and the same role playing games are in the standby state or the like, such another gaming apparatus 500 replies response information.

Accordingly, the communicator 540 determines whether or not response information is received.

When determining that there is no response (step S503: NO), the gaming apparatus 500 progresses the process to step S506 to be discussed later.

Conversely, when determining that there is a response (step S503: YES), the gaming apparatus 500 exchanges time tables (step S504).

That is, the communicator 540 reads the above-explained time table TL illustrated in FIG. 4 from the game information memory 110, transmits the read time table to another gaming apparatus 500, and receives a time table transmitted from another gaming apparatus 500.

The gaming apparatus 500 stores the received time table in the game information memory 110 (step S505).

That is, the communicator 540 adds the time table transmitted from another gaming apparatus 500 to the above-explained received time table JTL illustrated in FIG. 16 and stores such a time table. When the number of time tables that can be stored in the received time table JTL exceeds the upper limit number, a newly received time table is not stored and may be discarded, or times tables may be deleted oldest first, and the latest time table may be stored instead.

The gaming apparatus 500 determines whether or not the standby state ends (step S506). For example, the gaming apparatus 500 determines whether or not the screen of the gaming apparatus 500 in the suspended state is opened. That is, the gaming apparatus 500 determines whether or not the open/closed sensor 21 detects that the upper casing JC is opened.

When determining that the standby state does not end (step S506: NO), the gaming apparatus 500 returns the process to the step S502, and repeatedly executes the processes from the step S502 to the step S506.

Conversely, when determining that the standby state ends (step S506: YES), the gaming apparatus 500 transitions to a normal state (step S507).

After being transitioned to the normal state, the gaming apparatus 500 may display, for example, the number of time tables received from other gaming apparatuses 500.

The time table exchanging process enables an automatic exchange of time tables with another user (another gaming apparatus 500) met at a place where, for example, the user goes.

Next, an explanation will be given of the match-up control process with reference to FIG. 18. This match-up control process sequentially starts after the above-explained time table exchanging process illustrated in FIG. 17 completes. Note that when no time table is received at all through the time table exchanging process, this match-up control process does not start. When multiple time tables are received, for example, a selection screen or the like may be displayed prior to the start of the match-up control process to allow the user to select the received time table arbitrary.

In the match-up control process illustrated in FIG. 18, the same process content as that of the match-up control process (see FIG. 9) according to the above-explained first embodiment is denoted by the same reference numeral.

The gaming apparatus 500 reads the own time table (step S301). That is, the match-up controller 150 reads the time table TL stored in the standby state from the game information memory 110.

The gaming apparatus 500 reads the enemy time table (step S601). That is, the match-up controller 150 reads the above-explained received time table JTL (one time table) illustrated in FIG. 16 from the game information memory 110.

The gaming apparatus 500 generates data on the HP and the like of the enemy monster character (step S602). That is, the match-up controller 150 generates data on the HP and the like of the enemy monster character corresponding to the received time table JTL so as to be even to data on the HP and the like of the partner monster character. That is, the match-up controller 150 generates data on the HP and the like of the enemy monster character so as to be a closer value to data on the HP and the like of the partner monster character, and thus the battle of the partner and enemy monster characters is settled mainly based on the respective time tables.

The gaming apparatus 500 sets the variable i for managing the progress of the battle to be 1 that is the initial value (step S303), and reads data of the ith slot from each time table (step S304).

The gaming apparatus 500 causes the antecedent monster character to transform, and to attack or the like the competitor monster character in accordance with an instruction (step S305).

The gaming apparatus 500 determines whether or not the HP of the succedent monster character is greater than zero (step S306).

When determining that the HP of the succedent monster character is greater than zero (step S306: YES), the gaming apparatus 500 causes the succedent monster character to transform, and to attack or the like the competitor in accordance with an instruction (step S307).

The gaming apparatus 500 determines whether or not the HP of the antecedent monster character is greater than zero (step S308).

When determining that the HP of the antecedent monster character is larger than zero (step S308: YES), the gaming apparatus 500 adds 1 to the variable i (step S309), and determines whether or not the variable i after the addition is greater than 6 (step S310).

When determining that the variable i is equal to or smaller than 6 (step S310: NO), the gaming apparatus 500 returns the process to the above-explained step S304, and repeats the match-up at the following ith slot. Conversely, when determining that the variable i is greater than 6 (step S310: YES), the gaming apparatus 500 returns the process to the above-explained step S303, and repeats the battle in a sequential order from the first slot.

When determining that the HP of the monster character to which the attack was made in the above-explained steps S306 and S308 is zero (steps S306 and S308: NO), the gaming apparatus 500 determines the winner and the loser (step S311).

The gaming apparatus 500 determines whether or not the partner monster character is the winner (step S312) and when the partner monster character is the winner (step S312: YES), as an example, the gaming apparatus 500 increases the value of medals or the like accordingly (step S603).

Conversely, when determining that the partner monster character is the loser (the enemy monster character is the winner) (step S312: NO), as an example, the gaming apparatus 500 deletes the most inexpensive item from the items possessed by the partner monster character or the like (step S604).

The update target data at the time of winning or losing is optional, and can be changed accordingly.

The gaming apparatus 500 deletes the used enemy time table (step S605). That is, the determiner 170 deletes the received time table JTL (one time table) used for the match-up control from the game information memory 110.

The match-up control process enables an exchange of time tables to carry out a battle against an unknown competitor regardless of the progress of the game.

In the above-explained third embodiment, the explanation was given of the case in which the nearby gaming apparatuses 500 exchanges time tables, but the exchange of the time tables is not limited to the nearby gaming apparatuses 500, and can be changed accordingly. For example, arbitrary gaming apparatuses 500 may exchange time tables through a server (for example, a game server) over the Internet regardless of a distance between those gaming apparatuses 500.

In this case, the communicator 540 accesses the game server through a nearby access point while, for example, the game is intermitted, and exchanges time table with another gaming apparatus 500 through this game server.

### Fourth Embodiment

In the above-explained third embodiment, only time tables are exchanged with another gaming apparatus 500 through a wireless communication, but further other information is exchangeable. For example, a record of battles (battles performed regardless of the progress of the game) based on the time tables exchanged through wireless communications may be stored, and information (higher-rank winner information) on the higher rank winners obtained from that record may be exchanged together with the time table.

An explanation will be below given of a gaming apparatus 500 according to a fourth embodiment of the present invention which has a feature of further exchanging the higher-rank winner information.

The gaming apparatus 500 of the fourth embodiment of the present invention employs the same structure as that of the gaming apparatus 500 of the third embodiment illustrated in FIG. 15.

The game information memory 110, the communicator 540 and the determiner 170 performs further operations as follows.

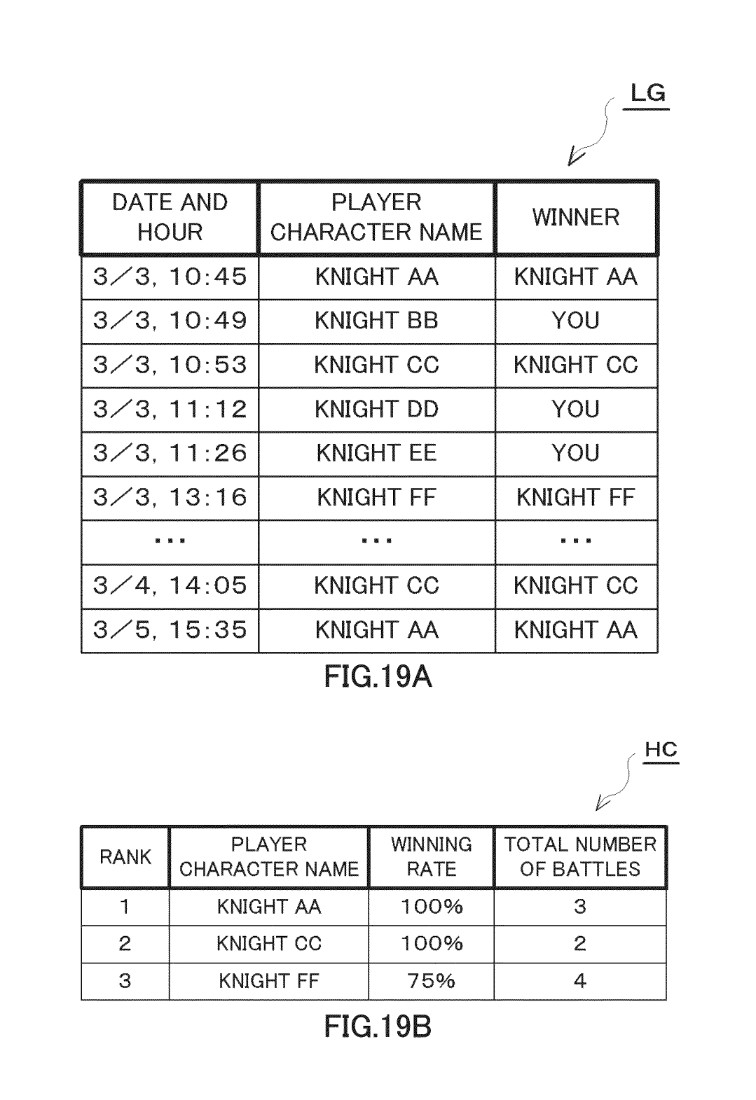

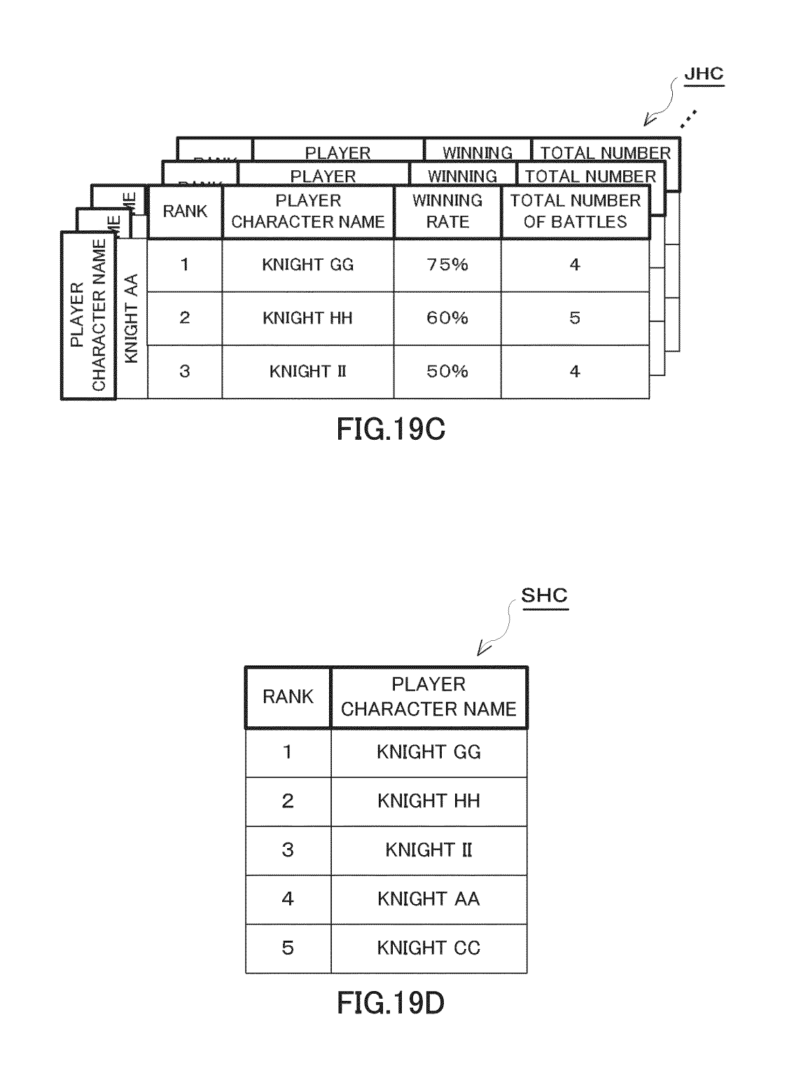

The game information memory 110 further stores match-up record information LG, higher-rank winner information HC, received higher-rank winner information JHC, and comprehensive higher-rank winner information SHC illustrated in FIGS. 19A to 19D.

The match-up record information LG illustrated in FIG. 19A indicates a record of battles performed regardless of the progress of the game. That is, the record of battles performed using time tables exchanged with another nearby gaming apparatus 500 while the played role playing game is in a standby state is successively stored.

More specifically, as illustrated in FIG. 19A, a record containing a date and hour, a player character name (the name of a matched-up enemy player character), and a winner is additionally stored in the match-up record information LG by the determiner 170 to be discussed later.

The higher-rank winner information HC illustrated in FIG. 19B sorts enemy player characters having won against the user in the order of a winning rate as an example. That is, the higher winning rate rankers tallied from the match-up record information LG are sorted up to a predetermined number (for example, top three winners). How to tally the higher-rank winner information HC and the number of the higher rankers are optional and can be changed and modified as needed.

More specifically, as illustrated in FIG. 19B, information containing a date and hour, a player character name (the name of a matched-up enemy player character), a winning rate, and the total number of battles is generated based on the match-up record information LG by the determiner 170 to be discussed later.

The higher-rank winner information HC is transmitted to another gaming apparatus 500 together with a time table by the communicator 540 to be discussed later.

The received higher-rank winner information JHC illustrated in FIG. 19C is stored higher-rank winner information received from another gaming apparatus 500.

More specifically, the higher-rank winner information (the same as the higher-rank winner information HC) received by the communicator 540 to be discussed later from another gaming apparatus 500 is added to the received higher-rank winner information JHC and stored. When new higher-rank winner information is transmitted from the same gaming apparatus 500, the new higher-rank winner information may be overwritten on the older higher-rank winner information, and may be added to the received higher-rank winner information.

The comprehensive higher-rank winner information SHC has the higher-rank winners sorted and comprehensively obtained from the higher-rank winner information HC and the received higher-rank winner information JHC. That is, although the local player character did not have a direct battle, the force thereof can be indirectly estimated from the received higher-rank winner information JHC corresponding to the player character in the higher-rank winner information HC. Hence, the higher rank winners determined comprehensively from such information are sorted up to a predetermined number (for example, top five characters). How to tally the comprehensive higher-rank winner information SHC and the number of the higher rankers are optional and can be changed as needed.

More specifically, the determiner 170 to be discussed later generates the comprehensive higher-rank winner information SHC illustrated in FIG. 19C based on the higher-rank winner information HC and the received higher-rank winner information JHC.

When the played role playing game becomes a standby state, the communicator 540 attempts to establish a wireless communication with another gaming apparatus 500 like the above-explained third embodiment. As an example, when response information is replied from another gaming apparatus 500 having received the reply request, a communication is enabled between the gaming apparatuses 500. As explained above, the communicator 540 may access the game server over the Internet through a nearby access point, and may perform a communication with another gaming apparatus 500 through this game server.

The communicator 540 reads the above-explained time table TL illustrated in FIG. 4, and the above-explained higher-rank winner information HC illustrated in FIG. 19B from the game information memory 110, and transmits those pieces of information to another gaming apparatus 500. At the time of transmission, the name of the local player character set in the role playing game is also transmitted.

The communicator 540 receives the time table and the higher-rank winner information transmitted from another gaming apparatus 500, and stores those pieces of information in the game information memory 110.

That is, the communicator 540 adds the received time table to the above-explained received time table JTL illustrated in FIG. 16 and stores such a table like in the third embodiment. The communicator 540 adds the received higher-rank winner information to the above-explained received higher-rank winner information JHC illustrated in FIG. 19C and stores such information. When newer higher-rank winner information is transmitted from the same gaming apparatus 500, the newer higher-rank winner information may be overwritten on the older higher-rank winner information, and may be added to the received higher-rank winner information JHC.

The determiner 170 determines a winner and a loser between the player character and enemy characters based on a result of a match-up control by the match-up controller 150 like the above-explained third embodiment. The determiner 170 accordingly updates information (for example, medals) stored in the game information memory 110 based on the determination result. The determiner 170 deletes the received time table JTL (one time table) used for the match-up control from the game information memory 110.

The determiner 170 updates the match-up record information based on the determination result. That is, the determiner 170 adds a present record (date and hour, player character name, and winner) based on a determination result to the above-explained match-up record information LG illustrated in FIG. 19A, and stores such new information.

When updating the match-up record information, the determiner 170 also updates (regenerates) the higher-rank winner information. That is, the determiner 170 tallies again the higher wining rate rankers from the match-up record information LG after the update, and regenerates the higher-rank winner information HC.

Furthermore, when updating the higher-rank winner information, the determiner 170 also updates the comprehensive higher-rank winner information. That is, the determiner 170 regenerates the comprehensive higher-rank winner information SHC based on the updated higher-rank winner information HC and the received higher-rank winner information JHC. That is, although the local player character did not have a direct battle, the force thereof can be indirectly estimated based on the received higher-rank winner information JHC corresponding to the player character of the higher-rank winner information HC. Hence, the determiner 170 obtains the higher-rank winners comprehensively determined from those pieces of information up to a predetermined number, and generates the comprehensive higher-rank winner information SHC.

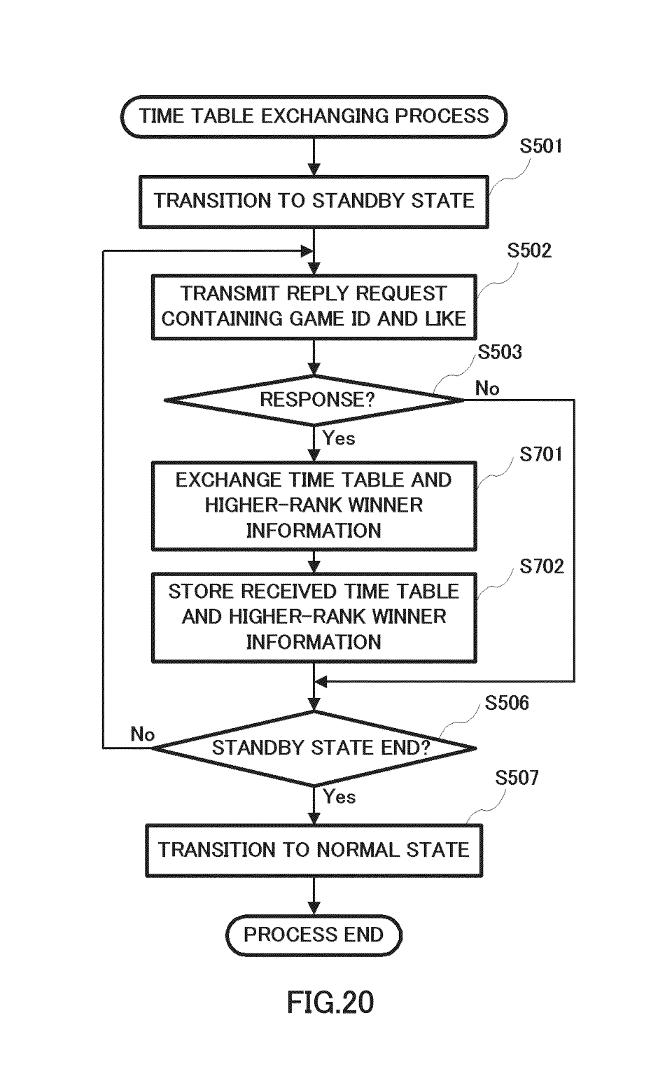

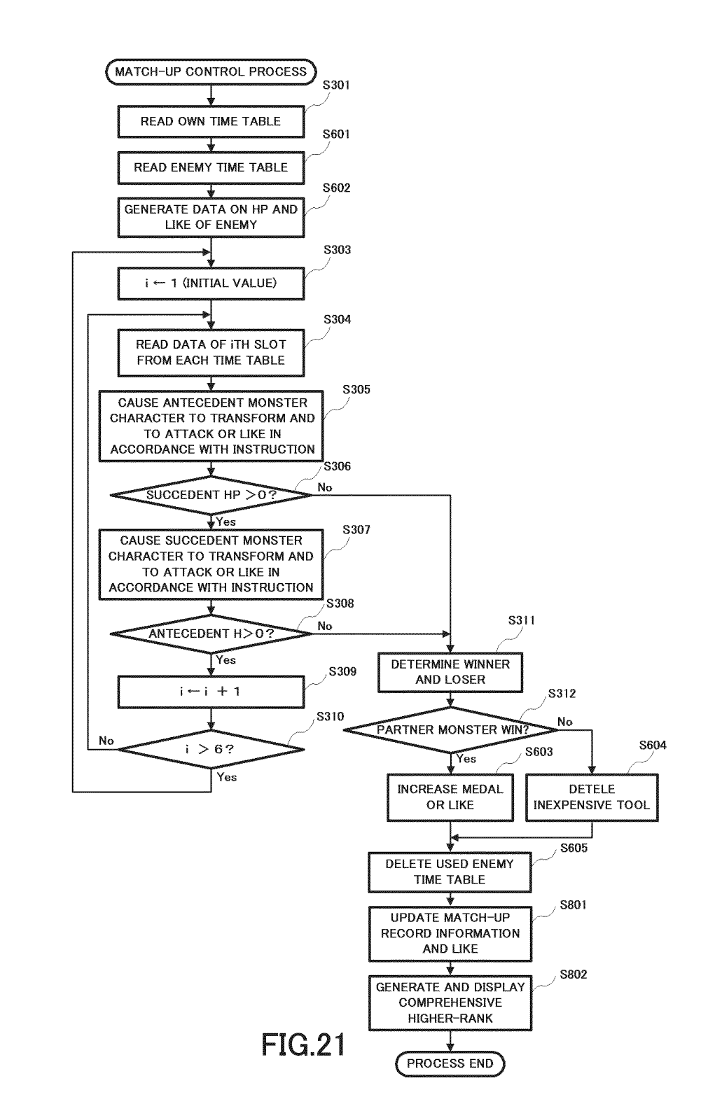

An explanation will below given of an operation the gaming apparatus 500 further exchanging the higher-rank winner information with reference to the drawings. FIG. 20 is a flowchart illustrating an example time table exchanging process executed by the gaming apparatus 500 according to the fourth embodiment of the present invention. FIG. 21 is a flowchart illustrating an example match-up control process executed by the gaming apparatus 500.

First, the time table exchanging process will be explained with reference to FIG. 20. This time table exchanging process starts when the power is turned on but the screen is closed with the above-explained time table setting process illustrated in FIG. 9 being executed and the game information memory 110 storing the time table TL.

In the time table exchanging process illustrated in FIG. 20, the same process content as that of the above-explained time table exchanging process (see FIG. 17) of the third embodiment is denoted by the same reference numeral.

When, for example, the power is maintained but the screen is closed, the gaming apparatus 500 transitions to the standby state (step S501).

The gaming apparatus 500 transmits a reply request containing the game ID and the like (step S502), and determined whether or not there is a response (step S503).

When determining that there is no response (step S503: NO), the gaming apparatus 500 progresses the process to step S506 to be discussed later.

Conversely, when determining that there is a response (step S503: YES), the gaming apparatus 500 exchanges time tables and higher-rank winner information (step S701).

That is, the communicator 540 reads the above-explained time table TL illustrated in FIG. 4 and the above-explained higher-rank winner information HC illustrated in FIG. 19B from the game information memory 110, and transmits those pieces of information to another gaming apparatus 500. At the time of transmission, the name of the local player character set in the role playing game is also transmitted.

The communicator 540 receives the time table and higher-rank winner information transmitted from another gaming apparatus 500.

The gaming apparatus 500 stores the received time table and higher-rank winner information in the game information memory 110 (step S702).

That is, the communicator 540 adds the time table transmitted from another gaming apparatus 500 to the above-explained received time table JTL illustrated in FIG. 16, and stores such a table. The communicator 540 adds the received higher-rank winner information to the above-explained received higher-rank winner information JHC illustrated in FIG. 19C and stores such information. When a newer higher-rank winner information is transmitted from the same gaming apparatus 500, the newer higher-rank winner information may be overwritten on the older higher-rank winner information, and may added to the received higher-rank winner information JHC.

The gaming apparatus 500 determines whether or not the standby state ends based on, for example, whether or not the screen is opened (step S506).

When determining that the standby state does not end (step S506: NO), the gaming apparatus 500 returns the process to the step S502, and repeatedly executes the processes from the step S502 to the step S506.

Conversely, when determining that the standby state ends (step S506: YES), the gaming apparatus 500 transitions to a normal state (step S507).

The time table exchanging process enables an automatic exchange of the time table and the higher-rank winner information with another user (another gaming apparatus 500) met at a place where, for example, the user goes.

Next, with reference to FIG. 21, the match-up control process will be explained. This match-up control process successively starts after the above-explained time table exchanging process illustrated in FIG. 20 ends. When no time table is received at all through the time table exchanging process, this match-up control process does not start. When multiple time tables are received, prior to the start of the match-up control process, for example, a selection screen is displayed to allow the user to select a received time table arbitrary.

In the match-up control process illustrated in FIG. 21, the same process content as that of the above-explained match-up control process (see FIG. 18) of the third embodiment is denoted by the same reference numeral.

The gaming apparatus 500 reads the own time table (step S301), and reads the enemy time table (step S601).

The gaming apparatus 500 generates data on the HP and the like of the enemy (step S602).

The gaming apparatus 500 sets the variable i for managing the progress of the battle to be 1 that is an initial value (step S303), and reads data on the ith slot from each time table (step S304).

The gaming apparatus 500 causes the antecedent monster character to transform, and to attack or the like in accordance with an instruction (step S305).

The gaming apparatus 500 determines whether or not the HP of the succedent monster character is greater than zero (step S306).

When determining that the HP of the succedent monster character is greater than zero (step S306: YES), the gaming apparatus 500 causes the succedent monster character to transform, and to attack or the like in accordance with an instruction (step S307).

The gaming apparatus 500 determines whether or not the HP of the antecedent monster character is greater than zero (step S308).

When determining that the HP of the antecedent monster character is greater than zero (step S308: YES), the gaming apparatus 500 adds 1 to the variable i (step S309), and determines whether or not the variable i after the addition is greater than 6 (step S310).

When determining that the variable i is equal to or less than 6 (step S310: NO), the gaming apparatus 500 returns the process to the above-explained step S304, and repeats the battle at a following slot i. Conversely, when determining that the variable i is greater than 6 (step S310: YES), the gaming apparatus 500 returns the process to the above-explained step S303, and repeats the battle in a sequential order from the first slot.

When determining that the HP of the monster character to which the attack was made in the steps S306, S308 is zero (steps S306 and S308: NO), the gaming apparatus 500 determines the winner and the loser (step S311).

The gaming apparatus 500 determines whether or not the partner monster character is the winner (step S312), and when determining that the partner monster character is the winner (step S312: YES), as an example, the gaming apparatus 500 increases the value of the medals or the like accordingly (step S603).

Conversely, when determining that the partner monster character is the loser (the enemy monster character is the winner) (step S312: NO), as an example, the gaming apparatus 500 deletes the most inexpensive tool among the tools possessed by the partner monster character or the like (step S604).

The gaming apparatus 500 deletes the used enemy time table (step S605).

The gaming apparatus 500 updates the match-up record information and the like (step S801). That is, the determiner 170 adds the current record (date and hour, player character name, and winner) base on a determination result to the above-explained match-up record information LG illustrated in FIG. 19A and stores such information.

When updating the match-up record information, the determiner 170 also updates (regenerates) the higher-rank winner information. That is, the determiner 170 tallies again the higher winning rate rankers from the updated match-up record information LG, and regenerates the higher-rank winner information HC.

The gaming apparatus 500 generates and displays the comprehensive higher-rank winner information (step S802). That is, the determiner 170 regenerates the comprehensive higher-rank winner information SHC based on the updated higher-rank winner information HC and the received higher-rank winner information JHC. That is, although the local player character did not battle directly, the force thereof can be indirectly estimated from the received higher-rank winner information JHC corresponding to the player character in the higher-rank winner information HC. Hence, the determiner 170 obtains the higher-rank winners comprehensively determined based on such information up to a predetermined number, and generates the comprehensive higher-rank winner information SHC.

The gaming apparatus 500 generates a predetermined notification image from the comprehensive higher-rank winner information SHC, displays such a notification image on the first display 18 or the like, thereby notifying the user of the comprehensive higher-rank winners.

The match-up control process enables an exchange of respective time tables and higher-rank winner information regardless of the progress of the game, allows the user to have a battle against an unknown enemy, and notifies the user of the comprehensive higher-rank winners including the player character with which the user does not directly have a battle.

### Other Embodiments

In each of the above-explained embodiments, the explanation was given of the case in which a time table using slots is used, but the content of this time table can be changed and modified as needed. For example, the time table may contain a number allocated to an activation of a monster character. That is, as long as the time table defines an activation sequence of a monster character or the like, the time table can be changed and modified as needed in accordance with the usage of a memory, communication traffic, and the like.

In each of the above-explained embodiment, two monster characters are caused to fight against each other in accordance with respective time tables, but the matter to have a battle against each other is not limited to such a monster character and can be changed as needed. For example, objects, such as a face card (a card or the like) representing the user or the like or an avatar, may have a fight against each other.

In each of the above-explained embodiment, the explanation was given of the case in which the gaming apparatuses 100 and 500 have a match-up within the game with other gaming apparatuses 100 and 500 (or CPUs), but the present invention is applicable to a so-called social game.

For example, the present invention can be realized by an application for a game which is executed based on an operation environment like an API (Application Programming Interface) operated over a web browser in a social networking service (SNS).

As explained above, according to the present invention, there are provided a gaming apparatus, a match-up control method, a computer-readable non-transitory information recording medium having stored therein a program, and a program that can further enhance a tactical performance in a game.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. A gaming apparatus that causes an object of a user to match up against another object, the gaming apparatus comprising:
a setter that sets a time table defining an activity sequence for an object;
a transmitter that transmits the set time table to another gaming apparatus;
a receiver that receives a competitor's time table transmitted from the another gaming apparatus;
a match-up controller that causes both objects to match up in sequence based on the set time table of the user and the received time table of the competitor;
a determiner that determines whether the user has won or lost based on a match-up result of the matched objects; and
an information memory that stores information on another user having a high winning rate with reference to the user based on the determination.

2. A gaming apparatus that causes an object of a user to match up against another object, the gaming device comprising:
a setter that sets, with a slot necessary for a match-up being as a unit, the object of the user in a time table defining each slot up to a predetermined number in association with each slot;
a transmitter that transmits the set time table to another gaming apparatus;
a receiver that receives a competitor's time table transmitted from the another gaming apparatus;
a match-up controller that causes both objects to match up for each slot based on the set time table of the user and the received time table of the competitor;
a determiner that determines whether the user has won or lost based on a match-up result of the matched-up objects against each other; and
an information memory that stores information on another user having a high winning rate with reference to the user based on the determination.

3. A gaming apparatus that causes a character available for a user to match up against a character available for a competitor, the gaming device comprising:
a memory that stores information on a plurality of characters available for the user;
a setter that sets, with a slot necessary for a match-up being as a unit, a character selected among the plurality of stored characters and an instruction to the selected character in a time table defining each slot up to a predetermined number in association with each slot;
a communicator which transmits the set time table to another gaming apparatus and which also receives a time table of a competitor transmitted from the another gaming apparatus at a predetermined timing;
a match-up controller that causes both characters to match up for each slot based on the set time table of the user and the received time table of the competitor;
a determiner that determines whether the user has won or lost based on a match-up result of the matched-up characters against each other; and
an information memory that stores information on another user having a high winning rate with reference to the user based on the determination.

4. The gaming apparatus according to claim 3, wherein the communicator transmits the set time table and the stored winner information to another gaming apparatus and receives the time table of the competitor and the winner information transmitted from the another gaming apparatus at a predetermined timing.

5. The gaming apparatus according to claim 3, wherein
when the gaming apparatus transitions to a standby state, the communicator exchanges the time tables with the another gaming apparatus through a wireless communication, and
the match-up controller causes both characters to match up against each other after the gaming apparatus transitions from the standby state to a normal state.

6. A match-up control method executed by a gaming apparatus which comprises a setter, a transmitter, a receiver, a match-up controller, a determiner and an information memory, and which causes an object of a user to match up against another object, the method comprising:
a setting step for causing the setter to set a time table defining an activity sequence for an object;
a transmitting step for causing the transmitter to transmit the set time table to another gaming apparatus;
a receiving step for causing the receiver to receive a time table of a competitor transmitted from the another gaming apparatus;
a match-up control step for causing the match-up controller to allow both objects to match up in sequence based on the set time table of the user and the received time table of the competitor;
a determining step for causing the determiner to determine whether the user has won or lost based on a match-up result of the matched objects; and
an information memory step for causing the information memory to store information on another user having a high winning rate with reference to the user based on the determination.

7. A computer-readable non-transitory information recording medium having stored therein a program that allows a computer which causes an object of a user to match up against another object to function as:
a setter that sets a time table defining an activity sequence for an object;
a transmitter that transmits the set time table to another gaming apparatus;
a receiver that receives a competitor's time table transmitted from the another gaming apparatus;
a match-up controller that causes both objects to match up in sequence based on the set time table of the user and the received time table of the competitor;
a determiner that determines whether the user has won or lost based on a match-up result of the matched objects; and
an information memory that stores information on another user having a high winning rate with reference to the user based on the determination.

8. A computer-readable non-transitory program that allows a computer which causes an object of a user to match up against another object to function as:
a setter that sets a time table defining an activity sequence for an object;
a transmitter that transmits the set time table to another gaming apparatus;
a receiver that receives a competitor's time table transmitted from the another gaming apparatus;
a match-up controller that causes both objects to match up in sequence based on the set time table of the user and the received time table of the competitor;
a determiner that determines whether the user has won or lost based on a match-up result of the matched objects; and
an information memory that stores information on another user having a high winning rate with reference to the user based on the determination.
